(19) United States
(12) Patent Application Publication
(10) Pub. No.: US 2025/0321696 A1
(43) Pub. Date: Oct. 16, 2025

(54) MANAGEMENT COMMAND MICROCODE TECHNIQUES FOR MEMORY ARCHITECTURES

(71) Applicant: Micron Technology, Inc., Boise, ID (US)

(72) Inventors: Chun-Yi Liu, Rancho Cordova, CA (US); Ameen D. Akel, Rancho Cordova, CA (US)

(21) Appl. No.: 19/098,806

(22) Filed: Apr. 2, 2025

Related U.S. Application Data
(60) Provisional application No. 63/634,780, filed on Apr. 16, 2024.

(51) Int. Cl. G06F 3/06

(52) U.S. Cl. CPC G06F 3/0659; G06F 3/0604; G06F 3/0689

(57) ABSTRACT

Methods, systems, and devices for management command microcode techniques for memory architectures are described. For example, interface circuitry of a memory system may be configured to determine that a management operation is to be performed, and may indicate a request to a controller of a host system to schedule aspects of the management operation. In response, the controller may indicate one or more commands to the interface circuitry to perform the management operation. Such techniques may involve the interface circuitry and controller being configured in accordance with a sequence of operations (e.g., a microcode), and respective management operations may each be associated with a pointer and a length of the sequence of operations. The controller may be configured to determine one or more commands for an indicated management operation by referencing the sequence of operations in accordance with the pointer and length associated with the indicated management operation.

### CROSS REFERENCE

The present application for patent claims priority to U.S. Patent Application No. 63/634,780 by Liu et al., entitled “MANAGEMENT COMMAND MICROCODE TECHNIQUES FOR MEMORY ARCHITECTURES,” filed Apr. 16, 2024, which is assigned to the assignee hereof, and which is expressly incorporated by reference in its entirety herein.

### TECHNICAL FIELD

The following relates to one or more systems for memory, including management command microcode techniques for memory architectures.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports management command microcode techniques for memory architectures in accordance with examples as disclosed herein.

FIG. 2 shows an example of a system that supports management command microcode techniques for memory architectures in accordance with examples as disclosed herein.

FIG. 3 shows an example of an interface architecture that supports management command microcode techniques for memory architectures in accordance with examples as disclosed herein.

FIG. 4 shows an example of a process that supports management command microcode techniques for memory architectures in accordance with examples as disclosed herein.

FIGS. 5A through 5C show examples of mappings that support management command microcode techniques for memory architectures in accordance with examples as disclosed herein.

FIG. 6 shows a block diagram of a memory interface block that supports management command microcode techniques for memory architectures in accordance with examples as disclosed herein.

FIG. 7 shows a block diagram of a memory controller that supports management command microcode techniques for memory architectures in accordance with examples as disclosed herein.

FIGS. 8 and 9 show flowcharts illustrating methods that support management command microcode techniques for memory architectures in accordance with examples as disclosed herein.

### DETAILED DESCRIPTION

Some semiconductor systems (e.g., memory systems, processor systems) may include a stack of semiconductor components (e.g., semiconductor dies), which may include one or more memory dies (e.g., array dies) and/or one or more stacks of memory dies that are stacked with a logic die that is operable to access a set of memory arrays distributed across the one or more memory dies. Such a stacked architecture may be implemented as part of a high bandwidth memory (HBM) system or a coupled dynamic random access memory (DRAM) system, among other examples, and may support solutions for memory-centric logic, such as graphics processing units (GPUs), among other implementations. In some examples, an HBM system may include one or more memory dies coupled (e.g., bonded, stacked) with a logic die. In some examples, a 3D stacked memory system may be closely coupled (e.g., physically coupled, electrically coupled, directly coupled) with a processor, such as a GPU or other host device, as part of a physical memory map accessible to the processor. A logic die may include various components such as interface blocks (e.g., memory interface blocks, interface circuitry), logic blocks, controllers, processors, and other components. A semiconductor component (e.g., a semiconductor unit, a semiconductor subsystem), such as a logic die, may be formed as a single die with relevant circuitry, or may be formed with multiple die portions (e.g., relatively smaller dies, dies each including a respective subset of components of a logic unit) that may be referred to as “chiplets” (e.g., logic chiplets), among other examples.

In some implementations, a memory system (e.g., of an HBM system, of a 3D stacked memory system) may perform management operations (e.g., memory management operations) to support or maintain operating characteristics of the memory system (e.g., performance characteristics for operating one or more memory arrays of the memory system). For example, such management operations may include refresh operations, adverse access (e.g., row hammer) mitigation operations, scrubbing operations, repair operations, and/or other operations. In some examples, logic of a memory system may be configured to determine when to perform management operations, which may involve coordination (e.g., scheduling, negotiation) of management operations with a host system that is coupled with the memory system. For example, management operations of a memory system may be coordinated with access operations (e.g., write operations, read operations) commanded by the host system to support an application of the host system.

In accordance with examples disclosed herein, a system may be configured to support management command signaling between one or more controllers (e.g., of a host system) and interface circuitry (e.g., of a memory system, a memory interface block) of a first semiconductor die that is configured for accessing one or more memory arrays (e.g., of the memory system) of one or more second semiconductor dies. For example, the interface circuitry may be configured to schedule or otherwise determine that a management operation is to be performed, and may indicate (e.g., signal) a request to at least one controller to schedule aspects of the management operation. In response, one or more controllers may indicate one or more commands to the interface circuitry to perform the management operation. In some examples, such techniques may involve the interface circuitry and the one or more controllers being configured in accordance with a sequence of operations (e.g., of a lookup resource, of a microcode, of a table), and respective management operations may each be associated with a pointer and a length of the sequence of operations. In some such examples, a controller (or in some examples multiple controllers) may be configured to determine one or more commands for a management operation that is indicated by interface circuitry by referencing the configured sequence of operations in accordance with the pointer and length that are associated with the indicated management operation.

By supporting implementations of management command signaling, the described techniques may support various improvements to operations of a system that includes a host system and a memory system, including implementations in a stacked semiconductor architecture. For example, by providing such an indication as a request to schedule aspects of the management operation (e.g., as a flexible request, as a request that may not be associated with an immediate response), a host system may be enabled to coordinate management operations with other operations (e.g., operations to support a function or application of the host system), such as access operations on one or more memory arrays of the memory system to support an application of the host system. Such techniques may allow the host system to prioritize relatively higher-priority access operations over the requested management operations. In some examples, such a request may include an indication of a duration within which a management operation is to be performed, which may support management operation commands being scheduled by the host system to be within a threshold duration that supports meeting an operating characteristic (e.g., reliability) of the memory system. In some examples, a management operation may be associated with a set (e.g., a sequence) of multiple operations (e.g., sub-operations, DRAM operations), such that a single request indication may be responded to with indications of a set of multiple commands in a manner that reduces request or command signaling (e.g., from the interface circuitry to the controller). In some implementations, such techniques may leverage an existing command set (e.g., a set of DRAM commands, a set of commands in accordance with a standardized interface protocol), which may support relatively simplified specification definitions, relatively simplified scheduling at the host system, and relatively flexible designs of or modifications to memory system interface circuitry, among other benefits.

In addition to applicability in memory systems as described herein, techniques for management command microcode may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve high-performance applications by improving signaling of memory management operations, and scheduling thereof, thereby enabling efficient and flexible techniques for memory interface circuitry to request memory management operations (e.g., to be performed within a requested duration), and for a host system to schedule responsive commands to perform the memory management operations along with scheduling of other operations, such as memory access operations. Such techniques may improve prioritization and allocation of resources between memory management and host applications, supporting high-performance host applications while meeting criteria for performance management of coupled memory arrays, among other benefits.

Features of the disclosure are illustrated and described in the context of systems and architectures. Features of the disclosure are further illustrated and described in the context of interface architectures, signaling diagrams, block diagrams, and flowcharts.

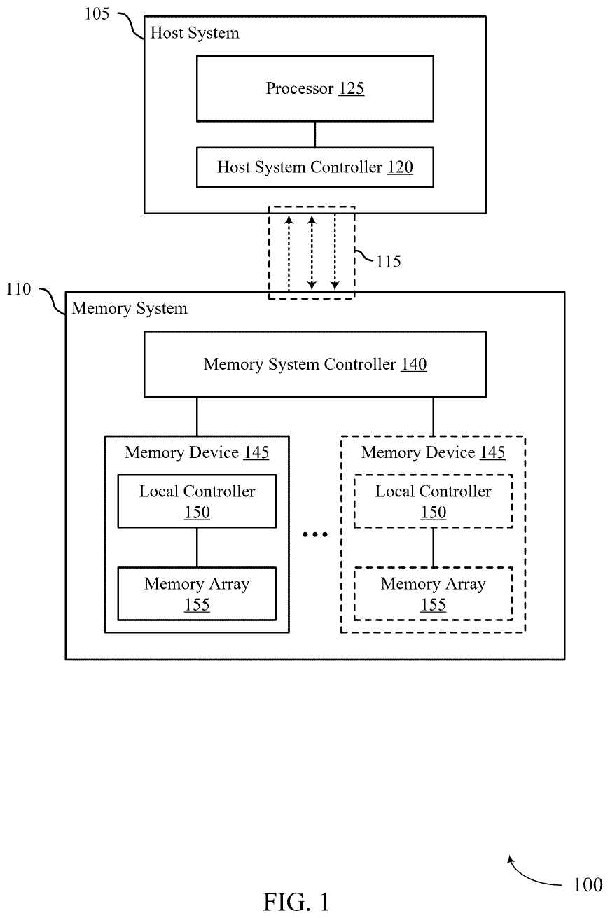

FIG. 1 shows an example of a system 100 that supports management command microcode techniques for memory architectures in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, application processing circuitry, one or more processing components) that use memory to execute processes (e.g., applications, functions, computations), any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

In some examples, the system 100 or the host system 105 may include an input component, an output component, or a combination thereof. Input components may include a sensor, a microphone, a key board, another processor (e.g., on a printed circuit board), an interface (e.g., a user interface, an interface between other devices), or a peripheral that interfaces with system 100 via one or more peripheral components, among other examples. Output components may include a display, audio speakers, a printing device, another processor on a printed circuit board, or a peripheral that interfaces with the system 100 via one or more peripheral components, among other examples.

The host system 105 may also include at least one of one or more components (e.g., circuitry, logic, instructions, which may be co-located or distributed among multiple locations) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or a combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, portions of a memory die) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions, which may be co-located or distributed among multiple locations) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not- and (NAND) memory cells, or any combination thereof.

A local controller 150 may include at least one of one or more components (e.g., circuitry, logic, instructions, which may be co-located or distributed among multiple locations) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, at least a portion of the system 100 may implement a stacked semiconductor architecture in which multiple semiconductor dies are physically and communicatively coupled (e.g., directly coupled, bonded). For example, at least one of the memory arrays 155 of a memory device 145 may be formed using one or more semiconductor dies (e.g., a single memory die, a stack of multiple memory dies), which may be stacked over another semiconductor die (e.g., a logic die) that includes at least a portion of a local controller 150. In some examples, a semiconductor die or die assembly may include at least a portion of or all of a local controller 150 and at least a portion of or all of a memory system controller 140, and such a semiconductor die or die assembly may be coupled with one or more memory dies, or one or more stacks of memory dies. In accordance with these and other examples, circuitry for accessing one or more memory arrays 155 (e.g., circuitry of a memory system 110) may be distributed among multiple semiconductor dies of a stack (e.g., a stack of multiple directly-coupled semiconductor dies). For example, a first die may include a set of multiple first interface blocks (e.g., memory interface blocks, instances of first interface circuitry) and one or more second dies may include corresponding second interface blocks, each coupled with a first interface block of the first die, which are each configured to access one or more memory arrays 155 of the second dies. In some examples, the system may include a controller (e.g., a memory controller, an interface controller, a host interface controller, at least a portion of a memory system controller 140) for each set of one or more first interface blocks to support access operations (e.g., to access one or more memory arrays 155) via the set of first interface blocks. In some examples, such a controller may be located in the same first die as the first interface blocks. In some examples, multiple semiconductor dies of a memory system 110 or of a system 100 (e.g., an HBM system including aspects of a memory system 110, a stacked semiconductor system including aspects of a memory system 110 and a host system 105) may include one or more array dies stacked with a logic die (e.g., that includes aspects of the host system 105, that is coupled with another die that includes the host system 105) that includes interface blocks operable to access a set of memory arrays 155 distributed across the one or more second dies.

A memory system 110 may perform management operations (e.g., memory management operations) to support or maintain operating characteristics of the memory system 110 (e.g., performance characteristics for operating one or more memory arrays 155 of the memory system 110). For example, such management operations may include refresh operations, adverse access (e.g., row hammer) mitigation operations, scrubbing operations, repair operations, or other operations. In some examples, logic of a memory system 110 (e.g., of a memory system controller 140, of one or more local controllers 150) may be configured to determine when to perform management operations, which may involve coordination (e.g., scheduling, negotiation) of management operations with a host system 105 that is coupled with the memory system 110. For example, management operations of a memory system 110 may be coordinated with access operations (e.g., write operations, read operations) commanded by the host system to support an application of the host system 105.

In accordance with examples disclosed herein, a system 100 may be configured to support management command signaling between one or more controllers (e.g., of a host system 105, a host system controller 120) and interface circuitry (e.g., of a memory system 110, of a memory system controller 140, of one or more local controllers 150) that is configured for accessing one or more memory arrays 155. For example, the interface circuitry may be configured to schedule or otherwise determine that a management operation is to be performed, and may indicate (e.g., signal) a request to at least one controller to schedule aspects of the management operation. In response, one or more controllers may indicate one or more commands to the interface circuitry to perform the management operation. In some examples, such techniques may involve the interface circuitry and the controller being configured in accordance with a sequence of operations (e.g., of a lookup resource, of a lookup table, of a microcode), and respective management operations may each be associated with a pointer and a length of the sequence of operations. In some such examples, a controller may be configured to determine one or more commands for a management operation that is indicated by interface circuitry by referencing the configured sequence of operations in accordance with the pointer and length that are associated with the indicated management operation.

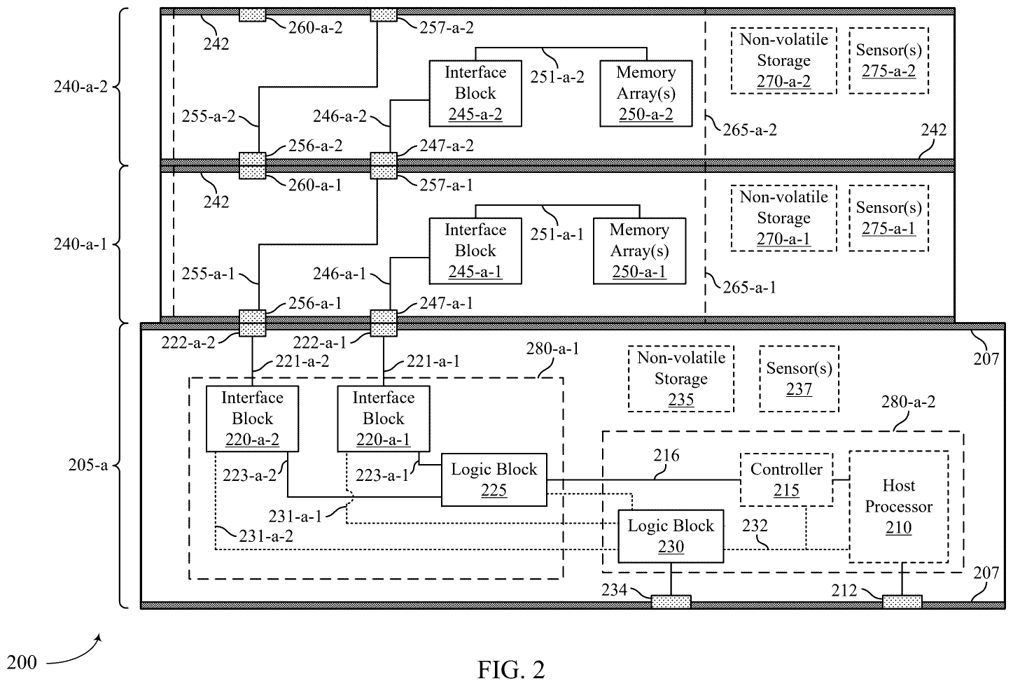

FIG. 2 shows an example of a system 200 (e.g., a semiconductor system, a system of coupled semiconductor dies, an HBM system, a 3D stacked memory system) that supports management command microcode techniques for memory architectures in accordance with examples as disclosed herein. The system 200 illustrates an example of a die 205 (e.g., a die 205-a, a semiconductor die, a logic die, a processor die, a host die, a logic unit) that is coupled with one or more dies 240 (e.g., dies 240-a-1 and 240-a-2, semiconductor dies, memory dies, array dies, memory units). A die 205 or a die 240 may be formed using a respective semiconductor substrate (e.g., a substrate of crystalline semiconductor material such as silicon, germanium, silicon-germanium, gallium arsenide, or gallium nitride), or a silicon-on-insulator (SOI) substrate (e.g., silicon-on-glass (SOG), silicon-on-sapphire (SOS)), or epitaxial semiconductor materials formed on another substrate, among other examples. Although the illustrated example of a system 200 includes two dies 240, a system 200 in accordance with the described techniques may include any quantity of one or more dies 240 (e.g., 8, 12, 16, or more dies 240) coupled with a die 205, among other dies of a stack or other coupled layout. Further, although non-limiting examples of the system 200 herein are generally described in terms of applicability to memory systems, memory sub-systems, memory devices, or a combination thereof, examples of the system 200 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

The system 200 illustrates an example of interface circuitry between a host and memory (e.g., via a host interface, via a physical host interface) that is implemented in (e.g., divided between) multiple semiconductor dies (e.g., a stack of directly-coupled dies). For example, the die 205-a may include a set of one or more interface blocks 220 (e.g., interface blocks 220-a-1 and 220-a-2, memory interface blocks), and each die 240 may include a set of one or more interface blocks 245 (e.g., access interface blocks) and one or more memory arrays 250 (e.g., die 240-a-1 including an interface block 245-a-1 coupled with a set of one or more memory arrays 250-a-1, die 240-a-2 including an interface block 245-a-2 coupled with a set of one or more memory arrays 250-a-2). The memory arrays 250 may be examples of memory arrays 155, and may include memory cells of various architectures, such as RAM, DRAM, SDRAM, SRAM, FeRAM, MRAM, RRAM, PCM, chalcogenide, NOR, or NAND memory cells, or any combination thereof.

Although the example of system 200 is illustrated with one interface block 245 included in each die 240, a die 240 in accordance with the described techniques may include any quantity of one or more interface blocks 245, each coupled with a respective set of one or more memory arrays 250, and each coupled with an interface block 220 of a die 205. Thus, the interface circuitry of a system 200 may include one or more interface blocks 220 of a die 205, with each interface block 220 being coupled with (e.g., in communication with) one or more interfaces block 245 of a die 240 (e.g., external to the die 205). In some examples, a coupled combination of an interface block 220 and an interface block 245 (e.g., coupled via a bus associated with one or more channels, such as one or more data channels, one or more control channels, one or more clock channels, one or more pseudo-channels, or a combination thereof) may include or be referred to as a data path associated with a respective set of one or more memory arrays 250.

In some implementations, a die 205 may include a host processor 210. A host processor 210 may be an example of a host system 105, or a portion thereof (e.g., a processor 125, aspects of a host system controller 120, or both). The host processor 210 may be configured to perform operations that implement storage of the memory arrays 250 (e.g., to support an application or other function of a host system 105, which may request access to the memory arrays 250). For example, the host processor 210 may receive data read from the memory arrays 250, or may transmit data to be written to the memory arrays 250, or both (e.g., in accordance with an application or other operations of the host processor 210). Additionally, or alternatively, a host processor 210 may be external to a die 205 (e.g., in HBM implementations), such as in another semiconductor die or other component that is coupled with (e.g., communicatively coupled with, directly coupled with, bonded with, coupled via another intervening component) the die 205 via one or more contacts 212 (e.g., externally-accessible terminals of the die 205).

A host processor 210 may be configured to communicate (e.g., transmit, receive) signaling with interface blocks 220 via a host interface 216 (e.g., a physical host interface), which may implement aspects of channels 115. For example, a host interface 216 may be configured in accordance with an industry standard, which may define channels, commands, clocking, and deterministic responses and timing, among other characteristics of the host interface 216. In some examples, a host interface 216 may provide a communicative coupling between physical or functional boundaries of a host system 105 and a memory system 110. For example, the host processor 210 may be configured to communicate access signaling (e.g., control signaling, access command signaling, data signaling, configuration signaling, clock signaling) via a host interface 216 to support access operations (e.g., read operations, write operations) on the memory arrays 250, among other operations. Although the example of system 200 includes a single host interface 216, a system in accordance with the described techniques may include any quantity of one or more host interfaces 216 for accessing memory arrays 250 of the system.

In some examples, a respective host interface 216 may be coupled between a set of one or more interface blocks 220 (e.g., interface blocks 220-a-1 and 220-a-2) and a respective controller 215. A controller 215 may be an example of control circuitry (e.g., memory controller circuitry, host interface control circuitry) associated with a host system 105, and may be associated with implementing respective instances of one or more aspects of a host system controller 120, or of a memory system controller 140, or a combination thereof. For example, a controller 215 may be operable to respond to indications (e.g., requests, commands) from the host processor 210 to access one or more memory arrays 250 in support of a function or application of the host processor 210, to transmit associated commands (e.g., for one or more interface blocks 220) to access the one or more memory arrays 250, and to communicate data (e.g., write data, read data) with the host processor 210, among other functions.

In some examples, one or more controllers 215 may be implemented in a die 205 (e.g., the same die that includes one or more interface blocks 220, in a 3D stacked memory implementation) whether a host processor 210 is included in the die 205, or is external to the die 205. In some other examples, controllers 215 or associated circuitry or functionality may be implemented external to a die 205 (e.g., in another die, not shown, coupled with respective interface blocks 220 via respective terminals for each of the respective host interfaces 216, in an HBM implementation), which may be in the same die as or a different die from a die that includes a host processor 210. An interface block 220 may be operable via a single controller 215, or by one or more of a set of multiple controllers 215 (e.g., in accordance with a controller multiplexing scheme). In some other examples, aspects of one or more controllers 215 may be included in the host processor 210 (e.g., as a memory interface of the host processor 210, as a memory interface of a host system 105).

Although, in some examples, a controller 215 may be directly coupled with one or more interface blocks 220 (not shown), in some other examples, a controller 215 (e.g., a host interface 216) may be coupled with a set of multiple interface blocks 220 via a logic block 225 (e.g., logic circuitry for a channel set, logic circuitry for a host interface 216, multiplexing circuitry). For example, the logic block 225 may be coupled with the interface block 220-a-1 via a bus 223-a-1 and coupled with the interface block 220-a-2 via a bus 223-a-2. A controller 215 and one or more corresponding interface blocks 220 and may communicate (e.g., collaborate) using the host interface 216 via a logic block 225 to perform one or more operations (e.g., scheduling operations, access operations, operations initiated by a host processor 210) associated with accessing a corresponding set of one or more memory arrays 250.

In some examples, a logic block 225, a controller 215, or a host interface 216, or a combination thereof may be associated with a “channel set” that corresponds to multiple memory arrays 250 (e.g., for parallel or otherwise coordinated access of the multiple memory arrays 250). For example, such a channel set may be associated with multiple memory arrays 250 accessed via a single interface block 245, or multiple memory arrays 250 each accessed via a respective one of the interface blocks 245, or multiple memory arrays 250 each accessed via a respective one of the interface blocks 220, any of which may be associated with signaling via a single logic block 225, via a single host interface 216, or via a single controller 215. These and other configurations for implementing one or more channel sets in a system may support various techniques for parallelism and high bandwidth data transfer, memory management operations, repair and replacement techniques, or power and thermal distribution, among other techniques that leverage the described coupling of components and interfaces among multiple semiconductor dies (e.g., in accordance with a high bandwidth configuration of the system 200, in accordance with a closely-coupled configuration of the system 200). In some examples, such techniques may be implemented (e.g., at or using a logic block 225) in a manner that is transparent to the host interface 216 or other aspects of a host system 105.

In some examples, a host interface 216 may include a respective set of one or more signal paths for each logic block 225 or interface block 220, such that the host processor 210 may communicate with each logic block 225 or interface block 220 via its corresponding set of signal paths (e.g., in accordance with a selection of the corresponding set to perform access operations via a logic block 225 or interface block 220 that is selected by the host processor 210). Additionally, or alternatively, a host interface 216 may include one or more signal paths that are shared among multiple logic blocks 225 (not shown) or interface blocks 220, and a logic block 225, an interface block 220, or a host processor 210, or any of these may interpret, ignore, respond to, or inhibit response to signaling via shared signal paths of the host interface 216 based on a logical indication (e.g., an addressing indication associated with the logic block 225 or interface block 220, an interface enable signal, or an interface select signal, which may be provided by the host processor 210, the corresponding logic block 225, or the corresponding interface block 220 depending on signaling direction).

In some examples, a host processor 210 may determine to access an address (e.g., a logical address of a memory array 250, a physical address of a memory array 250, an address of a logic block 225, an address of an interface block 220, an address of a host interface 216, in response to an application of or supported by the host processor 210), and determine which controller 215 to transmit access signaling to for accessing the address (e.g., a controller 215, logic block 225, or interface block 220 corresponding to the address). In some examples, the address may be associated with a row of memory cells of the memory array 250, a column of memory cells of the memory array 250, or both. The host processor 210 may transmit access signaling (e.g., one or more access signals, one or more access commands) to the determined controller 215 and, in turn, the determined controller 215 may transmit access signaling to the corresponding logic block 225 or interface block 220 (e.g., in accordance with a command and address protocol). The corresponding interface block 220 may subsequently transmit access signaling to the coupled interface block 245 to access the determined address (e.g., of a corresponding memory array 250).

A die 205 may also include a logic block 230 (e.g., a shared logic block, a central logic block, common logic circuitry, evaluation circuitry, memory system configuration circuitry, memory system management circuitry), which may be configured to communicate (e.g., transmit, receive) signaling with the logic blocks 225, the interface blocks 220, or both of the die 205. In some cases, a logic block 230 may be configured to communicate information (e.g., commands, instructions, indications, data) with one or more logic blocks 225 or interface blocks 220 to facilitate operations of the system 200. For example, a logic block 230 may be configured to transmit configuration signaling (e.g., initialization signaling, evaluation signaling, mapping signaling), which may be received by logic blocks 225 or interface blocks 220 to support configuration of the logic blocks 225 or interface blocks 220), or other aspects of operating the dies 240 (e.g., via the respective interface blocks 245). A logic block 230 may be coupled with each logic block 225 and each interface block 220 via a respective bus 231. In some examples, such buses may each include a respective set of one or more signal paths, such that a logic block 230 may communicate with each logic block 225 or each interface block 220 via the respective set of signal paths. Additionally, or alternatively, such buses may include one or more signal paths that are shared among multiple logic blocks 225 or interface blocks 220 (not shown).

In some implementations, a logic block 230 may be configured to communicate (e.g., transmit, receive) signaling with a host processor 210 or one or more controllers 215 (e.g., via a bus 232, via a contact 212 for a host processor 210) or controller 215 external to a die 205), such that the logic block 230 may support an interface between the host processor 210 or one or more controllers 215 and the logic blocks 225 or interface blocks 220. For example, a host processor 210 or a controller 215 may be configured to transmit initialization signaling (e.g., boot commands), or other configuration or operational signaling, which may be received by a logic block 230 to support initialization, configuration, evaluation, or other operations of the logic blocks 225 or interface blocks 220. Additionally, or alternatively, in some implementations, a logic block 230 may be configured to communicate (e.g., transmit, receive) signaling with a component outside the system 200 (e.g., via a contact 234, which may be an externally-accessible terminal of the die 205), such that the logic block 230 may support an interface that bypasses a host processor 210 or controller 215. Additionally, or alternatively, a logic block 230 may communicate with a host processor 210 or a controller 215, and may communicate with one or more memory arrays 250 of one or more dies 240) (e.g., to perform self-test operations for access of memory arrays 250)). In some examples, such implementations may support evaluations, configurations, or other operations of the system 200, via one or more contacts 234 that are accessible at a physical interface of the system, during manufacturing, assembly, validation, or other operation associated with the system 200 (e.g., before coupling with a host processor 210, without implementing a host processor 210, for operations independent of a host processor). Additionally, or alternatively, a logic block 230 may implement one or more aspects of a controller 215. For example, a logic block 230 may include or operate as one or more controllers 215 and may perform operations ascribed to a controller 215.

In some examples, respective signals may be routed between a die 205 die and one or more dies 240. For example, each interface block 220 may be coupled with at least a respective bus 221 of the die 205, and a respective bus 246 of a die 240, that are each configured to communicate signaling with a corresponding interface block 245 (e.g., via one or more associated signal paths). For example, the interface block 220-a-1 may be coupled with the interface block 245-a-1 via a bus 221-a-1 and a bus 246-a-1, and the interface block 220)-a-2 may be coupled with the interface block 245-a-2 via a bus 221-a-2 and a bus 246-a-2. In some examples, a die 240) may include a bus that bypasses operational circuitry of the die 240) (e.g., that bypasses interface blocks 245 of a given die 240), such as a bus 255. For example, the interface block 220-a-2 may be coupled with the interface block 245-a-2 of the die 240-a-2 via a bus 255-a-1 of the die 240-a-1, which may bypass interface blocks 245 of the die 240)-a-1. Such techniques may be extended for interconnection among more than two dies 240 (e.g., for interconnection via a respective bus 255 of multiple dies 240). In some implementations, at least a portion of a bus 221, a bus 246, or a bus 255, or any combination thereof may include one or more conductors in a redistribution layer (RDL) of a respective die (e.g., above or below a semiconductor substrate of the die). Additionally, or alternatively, in some implementations, at least a portion of a bus 221, a bus 246, or a bus 255, or any combination thereof may include one or more vias that are formed through a semiconductor substrate of a respective die (e.g., as one or more through-silicon vias (TSVs)).

The respective signal paths of buses 221, 246, and 255 may be coupled with one another, from one die to another, via various arrangements of contacts at the surfaces of interfacing dies (e.g., exposed contacts, metal surfaces of the respective dies). For example, the bus 221-a-1 may be coupled with the bus 246-a-1 via a contact 222-a-1 of (e.g., at a surface of) the die 205-a and a contact 247-a-1 of the die 240)-a-1, the bus 221-a-2 may be coupled with the bus 255-a-1 via a contact 222-a-2 of the die 205 and a contact 256-a-1 of the die 240-a-1, the bus 255-a-1 may be coupled with the bus 246-a-2 via a contact 257-a-1 of the die 240-a-1 and a contact 247-a-2 of the die 240-a-2, and so on. Although each respective bus is illustrated with a single line, coupled via singular contacts, it is to be understood that each signal path of a given bus may be associated with respective contacts to support a separate communicative coupling via each signal path of the given bus. In some examples, a bus 255 may traverse a portion of a die 240 (e.g., in an in-plane direction, along a direction different from a thickness direction, in a waterfall arrangement, in a staircase arrangement), which may support an arrangement of contacts 222 along a surface of a die 205, among other contacts, being coupled with interface blocks 245 of different dies 240 along a stack direction (e.g., via respective contacts 256 and 257 that are non-overlapping when viewed along a thickness direction).

The interconnection of interfacing contacts may be supported by various techniques. For example, in a hybrid bonding implementation, interfacing contacts may be coupled by a fusion of conductive materials (e.g., electrically conductive materials) of the interfacing contacts (e.g., without solder or other intervening material between contacts). For example, in an assembled condition, the coupling of the die 205-a with the die 240-a-1 may include a conductive material of the contact 222-a-2 being fused with a conductive material of the contact 256-a-1, and the coupling of the die 240-a-1 with the die 240-a-2 may include a conductive material of the contact 257-a-1 being fused with a conductive material of the contact 247-a-2, and so on. In some examples, such coupling may include an inoperative fusion of contacts (e.g., a non-communicative coupling, a physical coupling), such as a fusion of the contact 260-a-1 with the contact 256-a-2, neither of which are coupled with operative circuitry of the dies 240-a-1 or 240-a-2. In some examples, such techniques may be implemented to improve coupling strength or uniformity (e.g., implementing contacts 260, which may not be operatively coupled with an interface block 245 or an interface block 220), or such a coupling may be a byproduct of a repetition of components that, in various configurations, may be operative or inoperative. (e.g., where, for dies 240 with a common arrangement of contacts 256 and 257, contacts 256-a-1 and 257-a-1 provide a communicative path between the interface block 245-a-2 and the interface block 220-a-2, but the contacts 256-a-2 and 257-a-2 do not provide a communicative path between an interface block 245 and an interface block 220).

In some examples, a fusion of conductive materials between dies (e.g., between contacts) may be accompanied by a fusion of other materials at one or more surfaces of the interfacing dies. For example, in an assembled condition, the coupling of the die 205 with the die 240-a-1 may include a dielectric material 207 (e.g., an electrically non-conductive material) of the die 205-a being fused with a dielectric material 242 of the die 240-a-1, and the coupling of the die 240-a-1 with the die 240-a-2 may include a dielectric material 242 of the die 240-a-1 being fused with a dielectric material 242 of the die 240-a-2. In some examples, such dielectric materials may include an oxide, a nitride, a carbide, an oxide-nitride, an oxide-carbide, or other conversion or doping of a substrate material (e.g., a semiconductor substrate material) or other material of the die 205 or dies 240, among other materials that may support such fusion. However, coupling among dies 205 and dies 240 may be implemented in accordance with other techniques, which may implement solder, adhesives, thermal interface materials, and other intervening materials or combinations of materials.

In some examples, dies 240 may be coupled in a stack (e.g., forming a “cube” or other arrangement of dies 240), and one or more of such stacks may subsequently be coupled with a die 205 (e.g., in a stack-to-chip bonding arrangement). In some examples, respective set(s) of one or more dies 240 may be coupled with each die 205 of multiple dies 205 as formed in a wafer (e.g., in a chip-to-wafer bonding arrangement, in a stack-to-wafer bonding arrangement, before cutting the wafer of dies 205), and the dies 205 of the wafer, each coupled with their respective set(s) of dies 240, may be separated from one another (e.g., by cutting at least the wafer of dies 205, by singulation). In some other examples, respective set(s) of one or more dies 240 may be coupled with a respective die 205 after the die 205 is separated from a wafer of dies 205 (e.g., in a chip-to-chip bonding arrangement). In some other examples, a respective set of one or more wafers, each including multiple dies 240, may be coupled in a stack (e.g., in a wafer-to-wafer bonding arrangement). In various examples, such techniques may be followed by separating stacks of dies 240 from the coupled wafers, or the stack of wafers having dies 240 may be coupled with another wafer including multiple dies 205 (e.g., in a second wafer-to-wafer bonding arrangement), which may be followed by separating systems 200 from the coupled wafers. In some other examples, wafer-to-wafer coupling techniques may be implemented by stacking one or more wafers of dies 240 (e.g., sequentially) over a wafer of dies 205 before separation into systems 200, among other examples for forming systems 200.

The buses 221, 246, and 255 may be implemented to provide a configured signaling (e.g., a coordinated signaling, a logical signaling, modulated signaling, digital signaling) between an interface block 220 and a corresponding interface block 245, which may involve various modulation or encoding techniques by a transmitting interface block (e.g., via a driver component of the transmitting interface block). In some examples, such signaling may be supported by (e.g., accompanied by) clock signaling communicated via the respective buses (e.g., in coordination with signal transmission). For example, the buses may be configured to convey one or more clock signals transmitted by the interface block 220 for reception by the interface block 245 (e.g., to trigger signal reception by a latch or other reception component of the interface block 245, to support clocked operations of the interface block 245). Additionally, or alternatively, the buses may be configured to convey one or more clock signals transmitted by the interface block 245 for reception by the interface block 220) (e.g., to trigger signal reception by a latch or other reception component of the interface block 220, to support clocked operations of the interface block 220). Such clock signals may be associated with the communication (e.g., unidirectional communication, bidirectional communication, deterministic communication) of various signaling, such as control signaling, command signaling, data signaling, or any combination thereof. For example, the buses may include one or more signal paths for communications of a data bus (e.g., one or more data channels, a DQ bus, via a data interface of the interface blocks) in accordance with one or more corresponding clock signals (e.g., data clock signals), or one or more signal paths for communications of a control bus (e.g., a command/address (C/A) bus, via a command interface of the interface blocks) in accordance with one or more clock signals (e.g., control clock signals), or any combination thereof.

Interface blocks 220, interface blocks 245, logic blocks 225, and a logic block 230 each may include circuitry (signaling circuitry, multiplexing circuitry, processing circuitry, controller circuitry, logic circuitry, physical components, hardware) in various configurations (e.g., hardware configurations, logic configurations, software or instruction configurations) that support the functionality allocated to the respective block for accessing or otherwise operating a corresponding set of memory arrays 250. For example, interface blocks 220 may include circuitry configured to perform a first subset of operations that support access of the memory arrays 250, and interface blocks 245 may include circuitry configured to perform a second subset of operations that support access of the memory arrays 250. In some examples, the interface blocks 220, the interface blocks 245, and logic blocks 225 may support a functional split or distribution of functionality associated with a memory system controller 140, a local controller 150, or both across multiple dies (e.g., a die 205 and at least one die 240). In some implementations, a logic block 230 may be configured to coordinate or configure aspects of the operations of the interface blocks 220, of the interface blocks 245, of the logic blocks 225, or a combination thereof, and may support implementing one or more aspects of a memory system controller 140. Such operations, or subsets of operations, may include operations performed in response to commands from the host processor 210 or a controller 215, or operations performed without commands from a host processor 210 or a controller 215 (e.g., operations determined by or initiated by a logic block 225, operations determined by or initiated by an interface block 220, operations determined by or initiated by an interface block 245, operations determined by or initiated by a logic block 230), or various combinations thereof.

In some implementations, the system 200 may include one or more instances of non-volatile storage (e.g., non-volatile storage 235 of a die 205, non-volatile storage 270 of one or more dies 240, or a combination thereof). In some examples, a logic block 230, logic blocks 225, interface blocks 220, interface blocks 245, or a combination thereof may be configured to communicate signaling with one or more instances of non-volatile storage. For example, a logic block 230, logic blocks 225, interface blocks 220, or interface blocks 245 may be coupled with one or more instances of non-volatile storage via one or more buses (not shown), or respective contacts (not shown), where applicable, which may each include one or more signal paths operable to communicate signaling (e.g., command signaling, data signaling). In some examples, a logic block 230, one or more logic blocks 225, one or more interface blocks 220, one or more interface blocks 245, or a combination thereof may configure one or more operations based on information (e.g., instructions, configurations, parameters) stored in one or more instances of non-volatile storage. Additionally, or alternatively, in some examples, a logic block 230, one or more logic blocks 225, one or more interface blocks 220, one or more interface blocks 245, or a combination thereof may write information (e.g., configuration information, evaluation information) to be stored in one or more instances of non-volatile storage. In some examples, such non-volatile storage may include fuses, antifuses, or other types of one-time programmable storage elements, or any combination thereof.

In some implementations, the system 200 may include one or more sensors (e.g., one or more sensors 237 of a die 205, one or more sensors 275 of one or more dies 240, or a combination thereof). In some implementations, a logic block 230, logic blocks 225, interface blocks 220, interface blocks 245, or a combination thereof may be configured to receive one or more indications based on measurements of one or more sensors of the system 200. For example, a logic block 230, logic blocks 225, interface blocks 220, or interface blocks 245 may be coupled with one or more sensors via one or more buses (not shown), or respective contacts (not shown). Such sensors may include temperature sensors, current sensors, voltage sensors, counters, and other types of sensors. In some examples, a logic block 230, one or more logic blocks 225, one or more interface blocks 220, one or more interface blocks 245, or a combination thereof may configure one or more operations based on output of the one or more sensors. For example, a logic block 230 may configure one or more operations of logic blocks 225 or interface blocks 220 based on signaling (e.g., indications, data) received from the one or more sensors. Additionally, or alternatively, a logic block 225 or an interface block 220 may generate access signaling for transmitting to a corresponding interface block 245 based on one or more sensors.

In some examples, circuitry of logic blocks 225, interface blocks 220, interface blocks 245, or a logic block 230, or any combination thereof may include components (e.g., transistors) formed at least in part from doped portions of a substrate of the respective die. In some examples, a substrate of a die 205 may have characteristics (e.g., materials, material characteristics, physical shapes or dimensions) that are different from those of a substrate of a die 240. Additionally, or alternatively, in some examples, transistors formed from a substrate of a die 205 may have characteristics (e.g., manufacturing characteristics, performance characteristics, physical shapes or dimensions) that are different from transistors formed from a substrate of a die 240 (e.g., in accordance with different transistor architectures, in accordance with different transistor designs).

In some examples, the interface blocks 220 may support a layout for one or more components within the interface blocks 220. For example, the layout may include pairing components to share an access port (e.g., a command port, a data port). Further, in some examples, the layout may support interfaces for a controller 215 (e.g., a host interface 216) that are different from interfaces for an interface block 245 (e.g., via the buses 221). For instance, a host interface 216 may be synchronous and have separate channels for read and write operations, while an interface between an interface block 220 and one or more interface blocks 245 may be asynchronous and support both read and write operations with the same channel. In some examples, signaling of a host interface 216 may be implemented with a deterministic timing (e.g., deterministic between a controller 215 and a logic block 225 or one or more interface blocks 220), which may be associated with a configured timing between a first signal and a responsive second signal. In some examples, signaling between an interface block 220 and one or more interface blocks 245 may be implemented with a timing that is different from timing of a host interface 216 (e.g., in accordance with a different clock frequency, in accordance with a timing offset, such as a phase offset), which may be deterministic or non-deterministic.

A die 240 may include one or more units 265 (e.g., modules) that are separated from a semiconductor wafer having a pattern (e.g., a two-dimensional pattern) of units 265. Although each die 240 of the system 200 is illustrated with a single unit 265 (e.g., unit 265-a-1 of die 240-a-1, unit 265-a-2 of die 240-a-2), a die 240 in accordance with the described techniques may include any quantity of units 265, which may be arranged in various patterns (e.g., sets of one or more units 265 along a row direction, sets of one or more units 265 along a column direction, among other patterns). Each unit 265 may include at least the circuitry of a respective interface block 245, along with memory array(s) 250, a bus 251, a bus 246, and one or more contacts 247 corresponding to the respective interface block 245. In some examples, where applicable, each unit 265 may also include one or more buses 255, contacts 256, contacts 257, or contacts 260 (e.g., associated with a respective interface block 245 of a unit 265 of a different die 240), which may support various degrees of stackability or modularity among or via units 265 of other dies 240. Although examples of non-volatile storage 270 and sensors 275 are illustrated outside units 265, in some other examples, non-volatile storage 270, sensors 275, or both may additionally, or alternatively, be included in units 265.

In some examples, the interface blocks 220 may include circuitry configured to receive first access command signaling (e.g., from a host processor 210, from a controller 215, from a logic block 225, via a host interface 216, via one or more contacts 212 from a host processor 210 or controller 215 external to a die 205, based on a request from a host application), and to transmit second access command signaling to the respective (e.g., coupled) interface block 245 based on (e.g., in response to) the received first access command signaling. The interface blocks 245 may accordingly include circuitry configured to receive the second access command signaling from the respective interface block 220 and, in some examples, to access a respective set of one or more memory arrays 250 based on (e.g., in response to) the received second access command signaling. In various examples, the first access command signaling may include access commands that are associated with a type of operation (e.g., a read operation, a write operation, a refresh operation, a memory management operation), which may be associated with an indication of an address of the one or more memory arrays 250) (e.g., a logical address, a physical address). In some examples, the first access command signaling may include an indication of a logical address associated with the memory arrays 250, and circuitry of an interface block 220 may be configured to generate the second access command signaling to indicate a physical address associated with the memory arrays 250 (e.g., a row address, a column address, using a logical-to-physical (L2P) table or other mapping or calculation functionality of the interface block 220).

In some examples, to support write operations of the system 200, circuitry of the interface blocks 220 may be configured to receive (e.g., from a host processor 210, from a controller 215, from a logic block 225) first data signaling associated with the first access command signaling, and to transmit second data signaling (e.g., associated with second access command signaling) based on received first access command signaling and first data signaling. The interface blocks 245 may accordingly be configured to receive second data signaling, and to write data to one or more memory arrays 250 (e.g., in accordance with an indicated address associated with the first access command signaling) based on the received second access command signaling and second data signaling. In some examples, the interface blocks 220 may include an error control functionality (e.g., error detection circuitry, error correction circuitry, error correction code (ECC) logic, an ECC engine) that supports the interface blocks 220 generating the second data signaling based on performing an error control operation using the received first data signaling (e.g., detecting or correcting an error in the first data signaling, determining one or more parity bits to be conveyed in the second data signaling and written with the data).

In some examples, to support read operations of the system 200, circuitry of the interface blocks 245 may be configured to read data from the memory arrays 250 based on received second access command signaling, and to transmit first data signaling based on the read data. The interface blocks 220 may accordingly be configured to receive first data signaling, and to transmit second data signaling (e.g., to a host processor 210, to a controller 215, to a logic block 225) based on the received first data signaling. In some examples, the interface blocks 220 may include an error control functionality that supports the interface blocks 220 generating the second data signaling based on performing an error control operation using the received first data signaling (e.g., detecting or correcting an error in the first data signaling, which may include a calculation involving one or more parity bits received with the first data signaling).

In some examples, access command signaling that is transmitted to the interface blocks 245, among other signaling, may be generated (e.g., based on access command signaling received from a host processor 210, based on initiation signaling received from a host processor 210, without receiving or otherwise independent from signaling from a host processor 210) in accordance with various determination or generation techniques configured at the interface blocks 220 or the logic blocks 225 (e.g., based on a configuration for accessing memory arrays 250 that is modified at the interface blocks 220 or the logic blocks 225). In some examples, such techniques may involve signaling or other coordination with a logic block 230, a logic block 225, a host processor 210, one or more controllers 215, one or more instances of non-volatile storage, one or more sensors, or any combination thereof. Such techniques may support the interface blocks 220 or logic blocks 225 configuring aspects of the access operations performed on the memory arrays 250 by a respective interface block 245, among other operations. For example, interface blocks 220 or logic blocks 225 may include evaluation circuitry, access configuration circuitry, signaling circuitry, scheduling circuitry, repair circuitry, refresh circuitry, error control circuitry, adverse access (e.g., row hammer) mitigation circuitry, and other circuitry operable to configure operations associated with one or more dies (e.g., operations associated with accessing memory arrays 250 of the dies 240).

In some examples, functionality of a die 205 may be implemented as a semiconductor unit (e.g., a semiconductor system) that is formed with multiple semiconductor die portions (e.g., semiconductor chiplets, relatively smaller semiconductor dies), and each die portion may include respective portions of circuitry associated with the die 205. For example, a unit 280 may represent a portion of the circuitry components included in a die portion (e.g., in a chiplet), and the die portion may include an integer multiple of units 280. In some examples, each semiconductor die portion of a semiconductor unit may include different respective portions of circuitry. As a non-limiting example, a semiconductor unit (e.g., having the functionality of a die 205) may be formed by one or more first die portions having one or more units 280-a-1 and one or more second die portions having one or more units 280-a-2. The one or more units 280-a-1 may include one or more interface blocks 220, a logic block 225, or any combination thereof, and the one or more units 280-a-2 may include a host processor 210, one or more controllers 215, a logic block 230, or any combination thereof.

A system 200 may be configured to perform management operations to support or maintain operating characteristics, such as performance characteristics associated with operating one or more memory arrays 250. To support such techniques in accordance with examples as disclosed herein, a system 200 may be configured to support management command signaling (e.g., including signaling over a host interface 216, between controllers 215 and interface blocks 220, between components of a host system 105 and a memory system 110). For example, interface circuitry (e.g., interface blocks 220, logic blocks 225, or a logic block 230, or any combination thereof) may be configured to schedule or otherwise determine that a management operation is to be performed, and may indicate (e.g., signal) a request for a controller 215 to schedule aspects of the management operation. In response, the controller 215 may indicate one or more commands for an interface block 220 to perform the management operation.

The described techniques for management operations may support various improvements to operations of the system 200. For example, by providing such an indication of a management operation as a request to schedule aspects of the management operation (e.g., as a flexible request, as a request that may not be associated with an immediate response), a controller 215, a host processor 210, or a combination thereof may be enabled to coordinate management operations with other operations (e.g., operations to support a function or application of or using the host processor 210), such as access operations on one or more memory arrays 250. Such techniques may allow the controller 215 or host processor 210 to prioritize relatively higher-priority access operations over or in parallel with the requested management operations, which may include delaying management operations, using a different controller 215 to support access operations (e.g., selecting an available controller 215, an available host interface 216, or an available interface block 220, or a combination thereof that is not associated with requested management operations), among other scheduling or prioritization.

In some examples, such a request may include an indication of a duration within which a management operation is to be performed, such as a quantity of cycles (e.g., computation cycles, clock cycles, system cycles) between signaling of a management operation request and an initiation or a completion of the management operation. Such techniques may support management operation commands being scheduled by the controller 215 to be within a threshold duration that supports the system 200 meeting a desired operating characteristic (e.g., in support of a performance requirement associated with accessing the memory arrays 250).

In some examples, a management operation may be associated with a set (e.g., a sequence) of multiple operations (e.g., sub-operations, DRAM operations), such that a single request indication may be responded to by a controller 215 with indication (e.g., multiple indications, a sequence of indications, a compound command) of a set of commands in a manner that reduces request or command signaling (e.g., to the controller 215, over a host interface 216). In some implementations, such techniques may leverage an existing command set (e.g., a set of commands in accordance with a standardized interface protocol, a set of DRAM commands). For example, a first management operation may be associated with a first sequence of one or more DRAM commands, or timing thereof, or both (e.g., in accordance with a first management operation identifier), and a second management operation may be associated with a second sequence of one or more DRAM commands, or timing thereof, or both (e.g., in accordance with a second management operation identifier). In some implementations, such associations between management operations and commands may be stored at the system (e.g., in non-volatile storage 235, or non-volatile storage 270, or a combination thereof), and may be signaled to the controllers 215 (e.g., in a boot sequence, in an initialization sequence, in a configuration sequence, over a host interface 216). For example, such associations may be programmed (e.g., as instructions, as configuration parameters, during manufacturing or configuration of a die 205 or a die 240) or updated (e.g., via a logic block 230, via contacts 234, by way of flashing instructions or parameters, before or after coupling the stack of dies), which may facilitate programming or updating such associations without involving other design coordination between interface blocks 220 and controllers 215 (e.g., without requiring an update to a specification of a host interface 216).

In some examples, the system 200 may be configured in accordance with a sequence of operations (e.g., of a lookup resource, of a lookup table, of a microcode, of a resource accessible to one or more controllers 215, stored in non-volatile storage 235, stored in non-volatile storage 270), and respective management operations may each be associated with a pointer and a length of the configured sequence of operations (e.g., each referring to a subset of the sequence of operation). In some such examples, a controller 215 may be configured to determine one or more commands for a management operation that is indicated by interface circuitry by referencing the configured sequence of operations in accordance with the pointer and length that are associated with the indicated management operation.

Additionally, or alternatively, criteria for performing management operations (e.g., selection criteria, determination criteria, scheduling criteria) may be stored at the system 200 (e.g., in non-volatile storage 235, or non-volatile storage 270, or a combination thereof), which may be withheld from controllers 215 and a host processor 210. For example, scheduling details or initiation criteria for performing management operations may be programmed (e.g., as instructions, as configuration parameters, as parameters based on indications from one or more sensors 237 or sensors 275) or updated (e.g., via a logic block 230, via contacts 234) without such information being shared with a provider (e.g., designer, manufacturer) of the host processor 210 or controllers 215, among other aspects of the system 200. In some examples, such techniques for storing criteria for performing management operations may obscure such techniques from being discovered.

Thus, in accordance with these and other techniques, a system 200 may be configured in a manner that supports relatively simplified specifications for a host interface 216 to support management operations for maintaining performance of the system 200, relatively simplified scheduling at a controller 215 to support such management operations, and relatively flexible designs of or modifications to memory system interface circuitry (e.g., interface blocks 220, logic blocks 230) to such support management operations, among other benefits. Such techniques may be beneficial in a system of coupled semiconductor dies and other implementations, including benefits to improve throughput, to improve prioritization of operations, and to reduce latency, among other benefits.

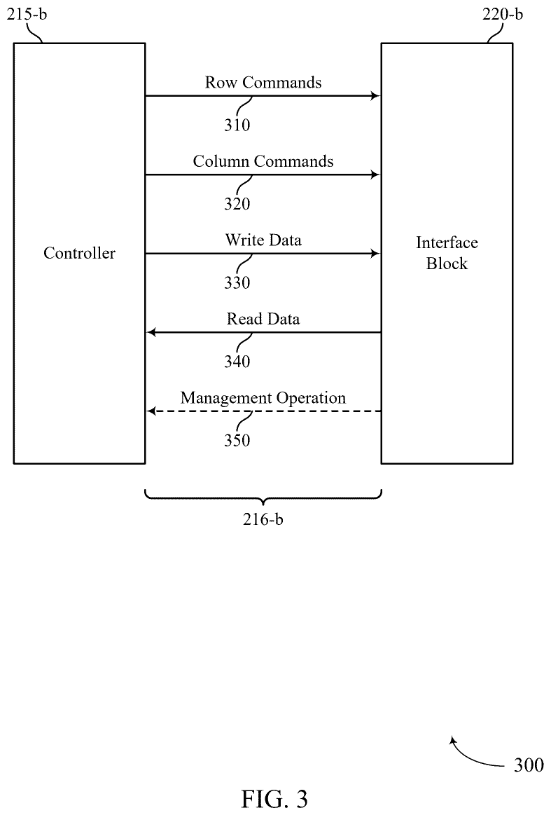

FIG. 3 shows an example of an interface architecture 300 that supports management command microcode techniques for memory architectures in accordance with examples as disclosed herein. The interface architecture 300 illustrates an example of an interface block 220-b (e.g., of a memory system 110, of a die 205) coupled with a controller 215-b (e.g., of a host system 105, of the die 205, external to the die 205). In some examples, the controller 215-b may support operations of a host system 105, such as coordinating access operations in response to operations (e.g., indications, requests, commands) of a host application. The interface block 220-b may include logic (e.g., interface logic, management logic, media management logic) configured for determining to perform management operations of a memory system 110, such as management operations to support operations associated with accessing memory arrays 250 (e.g., of one or more dies 240)), and transmitting requests for such management operations to be scheduled (e.g., by the controller 215-b). In some examples, the interface block 220-b may be illustrative of a single-channel memory interface block, but the described techniques may be applicable to any quantity of channels or pseudo channels of a system 200.

The controller 215-b may be communicatively coupled with the interface block 220-b via one or more of a bus 310, a bus 320, a bus 330, a bus 340, and a bus 350, each of which may be examples of one or more signal paths of a host interface 216-b (e.g., directly between the controller 215-b and interface block 220-b, or via a logic block 225). For example, a bus 310 may be associated with one or more signal paths for conveying row command information from the controller 215-b to the interface block 220-b, such as respective or shared signal paths for conveying activation commands and precharge commands with accompanying address information (e.g., channel information, pseudo-channel information, bank information, row information). The bus 320 may be associated with one or more signal paths for conveying column command information from the controller 215-b to the interface block 220-b, such as respective or shared signal paths for conveying read commands and write commands with accompanying address information (e.g., column information). Although the bus 310 and the bus 320 are illustrated separately, a bus 310 and a bus 320 may, in some examples, be implemented in a common bus (e.g., a command/address (CA) bus) that supports conveying row command information and column command information via various configurations of one or more signal path. In some examples, signal paths of a bus 310, a bus 320, or both may have corresponding signal paths included in a bus 301 (e.g., between the interface block 220-b and an interface block 245). The bus 330 may be associated with one or more signal paths (e.g., 64 signal paths) for conveying write data from the controller 215-b to the interface block 220-b, and the bus 340 may be associated with one or more signal paths (e.g., 64 signal paths) for conveying read data from the interface block 220-b to the controller 215-b. Although the bus 330 and the bus 340 are illustrated separately (e.g., as unidirectional buses), a bus 330 and a bus 340 may, in some examples, be implemented in a common bus (e.g., a bidirectional bus, a DQ bus) that supports conveying write data and read data via the same signal path(s).

The host interface 216-b may support a command interface (e.g., a deterministic interface) for indications such as activation commands, precharge commands, read commands, and write commands, among others, which may be configured to operate in accordance with configured (e.g., predetermined, published, deterministic) timings and responses (e.g., responsive operations, responsive signaling). For example, the controller 215-b may be configured to handle command scheduling, which may include a combination of scheduling commands for access operations to support a host application and scheduling commands to support management operations (e.g., requested by the interface block 220-b). In some implementations, such commands may be configured in accordance with a memory protocol (e.g., a DRAM protocol). For example, a set of commands that may be configured between the controller 215-b and the interface block 220-b (e.g., a command set supported over the host interface 216-b) may include an activate command (e.g., an ACT command), a precharge command (e.g., a PRE command), an row-no-operation (e.g., RNOP) command, a read command (e.g., an RD command), a command for a read with auto-precharge (e.g., an RDA command), a write command (e.g., a WR command), a command for a write with auto-precharge (e.g., a WRA command), or a column-no-operation command (e.g., a CNOP command), among others commands or combinations thereof. In some examples, such commands may be accompanied by one or more delay commands, which may be used to configure or request a delay (as a quantity of cycles) between other operations.

Table 1 illustrates an example of commands and associated identifiers that may be available for association with a given management operation:

TABLE 1
Example Commands for Management Operation Associations

| Command | ID |
|---|---|
| NOP | 0 |
| RNOP | 1 |
| ACT | 2 |
| PRE | 3 |
| CNOP | 4 |
| WR | 5 |
| WRA | 6 |
| RD | 7 |
| RDA | 8 |
| Wait 2c | 9 |
| Wait 4c | 10 |
| Wait 8c | 11 |
| Wait 16c | 12 |
| Wait 32c | 13 |
| Reserved | 14 |
| Reserved | 15 |

In some examples, such commands may be a configured set of possible commands known to a host system 105 (e.g., to the controller 215-b) and to a coupled memory system 110 (e.g., to the interface block 220-b) at the time of system design. In various examples, any one or more of such commands may be associated with a management operation (e.g., by command ID, by one or more management operation indicators) that may be requested by the interface block 220-b and scheduled by the controller 215-b (e.g., as commands for a compound operation).

In some implementations, such commands may follow the same timing constraints (e.g., DRAM timing constraints) whether they are used to support a host application or a management operation. For example, the controller 215-b, the interface block 220-b, or both may also be configured with command timings in accordance with a memory protocol (e.g., a DRAM protocol), with may include configured timings such as a row-to-column delay for read operations (e.g., tRCDR), a row-to-column delay for write operations (e.g., tRCDW), a row precharge timing (e.g., tRP), a row active time (e.g., tRAS), a row cycle time (e.g., tRC), a row-to-row or RAS-to-RAS delay timing (e.g., tRRD), a write recovery time (e.g., tWR), a read-to-write delay timing (e.g., tRTW), a write-to-read delay timing (e.g., tWTR), a column-to-column delay timing (e.g., tCCD), among other timings or combinations thereof. Thus, with an understanding of configured commands and associated timings, the controller 215-b may be configured to schedule commands (e.g., in response to application requests, in response to management operation requests) that satisfy configured timing constraints in a manner that supports high performance of the associated host system 105, while also supporting management operations as determined by the associated memory system 110. By mapping management operations to known commands and timings, such techniques can be performed using a transparent interface with relatively fewer commands than if management operations were defined in accordance with new commands or timings.

The interface block 220-b may be configured to communicate a request to perform a management operation on one or more memory arrays 250) (e.g., a refresh operation, a row hammer mitigation operation, a scrubbing operation, a repair operation, a sparing operation, as determined by the interface block 220-b), which may be conveyed as a request for the controller 215 to schedule the interface block 220-b to perform the management operation. In some implementations, the host interface 216-c may be configured with a bus 350 (e.g., a bus dedicated to management operation requests, a unidirectional bus for signaling from the interface block 220-b to the controller 215-b), which may be associated with one or more signal paths that are dedicated to conveying management operation requests from the interface block 220-b to the controller 215-b. In some other implementations, such request signaling may be conveyed on a bus that is not dedicated to management operation requests, but is otherwise different from a bus for the interface block 220-b to receive commands from the controller 215-b (e.g., different from a bus 310) and a bus 320). Although, in some examples, a bus 350 may convey signaling from the interface block 220-b, in some other examples, signaling of a bus 350 may originate at a logic block 225, or a logic block 230, among other examples. In response to a management operation request, the controller 215-b, operating as a centralized scheduler, may schedule and transmit indications of one or more commands that are associated with the requested management operation, which may include a sequence of multiple commands (e.g., a combination of any one or more of an ACT command, a PRE command, an RNOP command, an RD command, an RDA command, a WR command, a WRA command, or a CNOP command) that are indicated in accordance with preconfigured timing constraints.

In some examples, the interface architecture 300 may be configured in accordance with a sequence of operations (e.g., of a lookup resource, of a lookup table, of a microcode, of a resource accessible to at least the controller 215-b, of non-volatile storage 235), and respective management operations may each be associated with a pointer and a length of the configured sequence of operations (e.g., each referring to a subset of the sequence of operation). For example, signaling over a bus 350 to indicate a management operation may include an indicator (e.g., a single indicator) of an identified management operation, or may include indications of a pointer and a length (e.g., two indicators) of the configured sequence of operations that is associated with an identified management operation. In some such examples, the controller 215-b may determine one or more responsive commands by referencing the configured sequence of operations in accordance with the pointer and length that are associated with the indicated management operation.

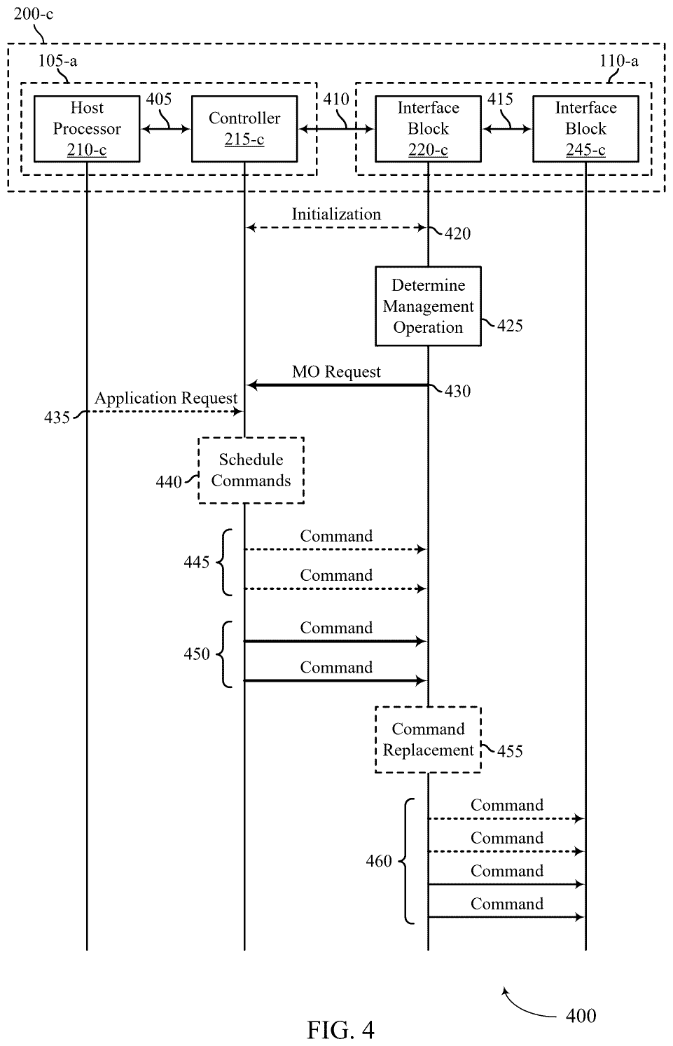

FIG. 4 shows an example of a process 400 that supports management command microcode techniques for memory architectures in accordance with examples as disclosed herein. Aspects of the process 400 may be performed by components of a system 200-c, such as a host processor 210-c, a controller 215-c, an interface block 220-c, and an interface block 245-c. The host processor 210-c and the controller 215-c may be components of a host system 105-a, and the interface block 220-c and the interface block 245-c may be components of a memory system 110-a (e.g., of a system 100). Although the example of the system 200-c includes a single controller 215-c that is coupled with a single interface block 220-c and a single interface block 245-c, the described techniques may be supported by one or more controllers 215-c that are coupled with any quantity of one or more interface blocks 220-c or any quantity of one or more interface blocks 245-c, among other implementations. Moreover, in some other examples, the memory system 110-a may also include a logic block 225, which may perform one or more of the operations described with reference to an interface block 220-c, or may convey signaling between the one or more controllers 215-c and the one or more interface blocks 220-c, or both (e.g., where the interface block and such a logic block 225 may be collectively referred to as an interface of the memory system 110-a).

In some implementations, the interface block 220-c may be a component of a first semiconductor component (e.g., a die 205) and the interface block 245-c and associated memory arrays 250 (not shown) may be components of a second semiconductor component (e.g., a die 240). In various implementations, the controller 215-c may be a component of the first semiconductor component or a component of another semiconductor component that is coupled with the second semiconductor component, and the host processor may be a component of the second semiconductor component, or another semiconductor component (e.g., a same die as the controller 215-c, a different die than the controller 215-c, in an HBM implementation), among other implementations.

The interface block 245-c may be coupled with the interface block via a bus 415, which may include one or more of a bus 221, a bus 246, or a bus 255. The interface block 220-c may be coupled with the controller 215-c via a bus 410, which may be an example of a host interface 216 (e.g., including one or more of a bus 310, a bus 320, a bus 330, a bus 340, or a bus 350). In some examples, such coupling or functionality may be conveyed or supported via a logic block 225. Additionally, or alternatively, operations described with reference to the interface block 220-c may be performed, in whole or in part, using a logic block 225 (not shown). The controller 215-c may be coupled with the host processor 210-c via a bus 405.

In some examples, at 420, the controller 215-c and the interface block 220-c may perform an initialization. For example, the controller 215-c and the interface block 220-c may exchange initialization signaling (e.g., via the bus 410), such as boot signaling, configuration signaling, instruction signaling, or other signaling, and may perform various accompanying operations. In some examples, at part of the initialization of 420, the interface block 220-c may transfer information regarding timings, associations of commands for various management operations, or a combination thereof (e.g., from non-volatile storage 235, from one or more instances of non-volatile storage 270, or a combination thereof). For example, the interface block 220-c may transmit an indication of a set of identifiers for a set of configured management operations and a respective set of one or more commands associated with each management operation of the set of management operations.

Additionally, or alternatively (e.g., omitting the initialization operations of 420), timings, associations of commands with management operations, or a combination thereof may be preconfigured one or both of the controller 215-c and the interface block 220-c. For example, such information may be included in a design specification (e.g., of the bus 410, of the controller 215-c, of the interface block 220-c), such that information regarding timings, associations of commands for various management operations, or a combination thereof may not be communicated from the interface block 220-c to the controller 215-c (e.g., during the initialization of 420 or otherwise). In some other examples, known associations of management operations and sequences of commands may be omitted, such that management operation requests themselves may include an indication of a requested set (e.g., sequence) of commands.

At 425, the interface block 220-c (e.g., a media management function) may determine a management operation to be performed. For example, the interface block 220-c (or logic block 225, where applicable) may determine that criteria for performing a management operation have been satisfied, which may be based on a duration since a prior management operation (e.g., in accordance with a management operation schedule), an indication from a sensor 237 or a sensor 275, an indication of adverse access operations, an indication of a component failure (e.g., an indication to perform a repair or sparing operation), among other criteria.

At 430 (e.g., in response to the determination of 425), the interface block 220-c (or logic block 225, where applicable) may transmit a management operation (MO) request (e.g., including at least an indication of a management operation, via the bus 410), which may be received by the controller 215-c. The request of 430 may be a request for the controller 215-c to schedule the interface block 220-c to perform a management operation associated with a memory array 250) accessible via the interface block 220-c (e.g., via the interface block 245-c). In some examples, the request of 430 may be transmitted via a dedicated signal path of the bus 410, such as bus 350. In various examples, the requested management operation may be a refresh operation on one or more rows of a memory array 250, a row hammer mitigation operation on one or more rows of a memory array 250, a scrubbing operation on one or more rows of a memory array 250), or a repair operation for one or more rows of a memory array 250, or another type of management operation.

A request of 430 may include one or more indications that are associated with a set of or one or more commands (e.g., a single command, a sequence of multiple commands, a compound command) that correspond to the management operation determined at 425. For example, a request of 430 may include an indication of an identifier associated with a requested management operation (e.g., an identifier that corresponds to the management operation, such as an identifier communicated during the initialization of 420 or otherwise configured or standardized between the controller 215-c and the interface block 220-c, an identifier of a type of management operation), where the identifier is known by the interface block 220-c and the controller 215-c to be associated with a set of one or more commands (e.g., a single command, a sequence of multiple commands). In some examples, the controller 215-c and the interface block 220-c may be configured in accordance with a sequence of operations (e.g., of a lookup resource, of a microcode, of a resource accessible to the controller 215-c, of non-volatile storage 235), and respective management operations may each be associated with a pointer (e.g., a starting index, a starting entry) and a length (e.g., a quantity of indices, a quantity of entries) of the configured sequence of operations (e.g., each management operation referring to a subset of the sequence of operation). In various examples of such techniques, the request of 430 may include an indication of a management operation that is associated (e.g., at the controller 215-c) with a pointer and a length that the controller 215-c may use to determine responsive comments, or the request of 430 may include indications of the pointer and length themselves (e.g., for a management operation that is not configured or otherwise known to the controller 215-c).

The request of 430 may be associated with various indications communicated to the controller 215-c. For example, a request of 430 may include an identifier (e.g., a tag) for associating responsive commands with the request 430, which may be used to map commands to the request of 430, to distinguish the management operation requested at 430 from other requested management operations, or both. In some examples, a request of 430 may include address information associated with the management operation (e.g., a pseudo-channel indicator, a bank indicator). In some examples, a request of 430 may include an indication of a duration (e.g., a deadline, a latency, a scheduling window, a duration relative to the timing of the transmission or receipt of the request of 430, a duration expressed as a quantity of system cycles) within which the controller 215-c is to schedule the interface block 220-c to perform the management operation. In some examples, such a duration may be configured to be as long as possible, while supporting a managed performance characteristic, to support relatively higher scheduling flexibility for the controller 215-c.

At 440 (e.g., based at least in part on the request of 430), the controller 215-c may schedule commands to transmit to the interface block 220-c (e.g., at least to perform the management operation requested at 430). In some examples, at least some of the commands scheduled at 440 may be commands to access one or more memory arrays 250 via the interface block 220-c (e.g., via the interface block 245-c). For example, the commands scheduled at 440 may include one or more row commands, one or more column commands, or a combination thereof. In some examples, the commands may be scheduled at 440) in accordance with an association of the commands with the requested management operation, such as an association communicated during the initialization of 430 or otherwise configured between the controller 215-c and the interface block 220-c. For example, when configured in accordance with a sequence of operations (e.g., of a lookup resource), the controller 215-c may be configured to determine one or more commands for the management operation requested at 430 by referencing the configured sequence of operations in accordance with the pointer and length that are associated with the indicated management operation. In some examples, the commands of 440 may be scheduled in accordance with configured timings between respective ones of the commanded operations (e.g., in accordance with configured delays).

In some examples, the commands scheduled at 440 for the requested management operation may be coordinated (e.g., by the controller 215-c) with other commands. For example, at 435 the host processor 210-c may transmit an application request (e.g., via the bus 405), which may be received by the controller 215-c. The application request of 435 may be a request for a write operation, or a read operation, or a combination thereof that supports a function or application of the host system 105-a. In some examples, the application request of 435 may be received as one or more commands to access one or more memory arrays 250 (e.g., a memory array 250 corresponding to the management operation requested at 430, a memory array 250 different from a memory array corresponding to the management operation requested at 430, or a combination thereof). In various examples, the application request of 435 may be received before the management operation request of 430 or after the management operation request of 430.

As part of the scheduling of 440, the controller 215-c may evaluate a relative priority of the application request of 435 and the management operation request of 430. For example, if the application request of 435 is of a relatively high priority, and a duration indicated by the management operation request of 430 supports it, the controller 215-c may be configured to schedule at least some of the commands responsive to the application request of 435 to be transmitted before at least some of the commands responsive to the management operation request of 430. In some examples, such scheduling may consider one or more other management operation requests (e.g., in addition to the management operation requested at 430), which may include prioritization or interleaving of commands for multiple requested management operations. Thus, the scheduling of 440 may support the controller 215-c optimizing command transmission among competing priorities for throughput, latency, reliability, stability, and other priorities.

At 450, the controller 215-c may transmit one or more commands (e.g., a single command, a sequence of multiple commands, via the bus 410) for the management operation corresponding to the request of 430, which may be received by the interface block 220-c. In some examples, each of the commands of 440 may include an indication (e.g., a tag, which may be the same tag that is indicated in the request of 430) that a command of 450 is associated with the request of 430 or is otherwise associated with the requested management operation. In some examples, the commands of 450 may include an indication of an address, such as an indication of a pseudo-channel or bank associated with the management operation request of 430.

In some examples (e.g., where applicable), at 445, the controller 215-c may transmit one or more commands (e.g., via the bus 410) which may be received by the interface block 220-c, where the commands of 445 may be responsive to an application request of 435, or another management operation request. In some examples, each of the commands of 450 may include an indication (e.g., a tag, an absence of a management operation indicator) that the command is not associated with a requested management operation, or an indication that the command is associated with a management operation different than the one requested at 430 (e.g., a different management operation). Although the commands of 445 are illustrated as being transmitted before the commands of 450 are transmitted, in various examples, one or more of the commands of 445 may be transmitted by the controller 215-c between the transmission of or receipt of the request of 430 and transmission of an initial command of commands 450, or transmitted by the controller 215-c between the commands of 450 (e.g., in accordance with an interleaving among the commands of 450 and the commands of 445), or transmitted by the controller 215-c after the commands of 450, or any combination thereof.

At 460, the interface block may transmit one or more commands that, in some examples, may each correspond to a received command (e.g., a command of 445, a command of 450), which may be received by the interface block 245-c (e.g., to access one or more memory arrays 250). In some examples, commands of 460 may be transmitted in accordance with a deterministic delay relative to the receipt of corresponding commands by the interface block 220-c (e.g., from the controller 215-c).

In some examples, the interface block 220-c may support a command replacement functionality, which may reduce an amount of information provided to the controller 215-c to support memory management operations (e.g., to reduce an amount of information that is signaled to the controller 215-c, to obscure memory management techniques performed by the interface block 220-c. For example, at 455, the interface block 220-c may replace one or more aspects of the commands of 450, or one or more of the commands of 450) themselves, with other aspects of commands (e.g., for transmission of the commands of 460).

In some examples, such a replacement may be based on whether a command from the controller 215-c is associated with a management operation. For example, if a command received at the interface block 220-c (e.g., a row command, a column command) includes a tag that indicates an association with the management operation request of 430 (e.g., of a command of 450), the interface block 220-c may replace the received command with a management command (e.g., a management row command, a management column command, to be transmitted at 460). In some examples (e.g., alternatively), if a command received at the interface block 220-c (e.g., a row command, a column command) does not include a tag that indicates an association with the management operation request of 430 (e.g., includes a tag that is not associated with a management operation, as a command of 445), the interface block 220-c may not replace the received command with a management command, but may forward the command to the interface block 245-c (e.g., at 460)).

In some examples, a replacement of 455 may include replacing one or more of the commands of 450 with a corresponding command of a different type for transmission at 460. For example, to obscure aspects of a refresh operation from the controller 215-c (e.g., to limit an awareness of the controller 215-c of particular rows being refreshed, among other aspects of the refresh management operation determined by the interface block 220-c), the interface block 220-c may request a management operation associated with an ACT command, a delay, and a PRE command (e.g., of commands at 450) and, after the interface block 220-c receives the commands, the interface block 220-c may replace the ACT command with a refresh command (e.g., at the same address as the ACT command) that performance a refresh on one or more rows (e.g., all rows) of the indicated bank, and replace the PRE command with an RNOP command (e.g., for forwarding to the interface block 245-c in the corresponding commands of 460). In some examples, such associations of commands with a management operation and corresponding replacements may be configured to satisfy timing constraints within the commands 450) and the commands 460.

Additionally, or alternatively, a replacement of 455 may include replacing address information included in one or more of the commands of 450 with new or updated address information for one or commands for transmission at 460. For example, the interface block 220-c may be configured to overwrite one or more fields in commands of 450 that are associated with a management operation (e.g., before forwarding to the interface block 245-c) for implementing the management operation, which may obscure aspects of addressing for the management operations from the controller 215-c. In some examples, the interface block 220-c may indicate request a management operation at 430 with a relatively coarse address indication (e.g., pseudo-channel, bank), which may be enough information to avoid command conflicts (e.g., for scheduling or prioritization at the controller 215-c), but the interface block 220-c may add address information at a finer granularity (e.g., inserting row information, column information, or both) for the commands of 460. Additionally, or alternatively, the interface block 220-c may be configured to confirm that audited commands (e.g., audited DRAM commands) follow the same timing constraints as commands that are not associated with management operations. Such configurations may minimize information (e.g., configuration information, timing information) involved with configuring the host interface 216, thereby simplifying aspects of management operation scheduling.

The process 400 may illustrate a functional division of techniques between one or more controllers 215-c and one or more interface blocks 220-c for supporting management operations of the memory system 110-a. For example, relative to command scheduling, a controller 215-c may have full control of scheduling, whereas an interface block 245-c may have no control of scheduling (e.g., outside of an indicated duration within which to schedule management operation commands). Regarding a configured command set, a controller 215-c may be configured for generating the commands, whereas an interface block 220-c, or a logic block 225, or both may be configured to generally pass through such commands (e.g., with the exception of replacement techniques of 455). Regarding the management operations themselves, one or more interface blocks 220-c, or a logic block 225, may be configured to determine the management operations and transmit requests to one or more controllers 215-c, whereas a controller 215-c may be configured to process such a request and issue responsive commands (e.g., commands of 450). Thus, the functional split illustrated by the process 400 for the system 200-c may support various improvements for scheduling flexibility, performance optimization, management operation definition and configuration, and obscuring of memory management techniques in a closely-coupled implementation of semiconductor components (e.g., dies), among other benefits.

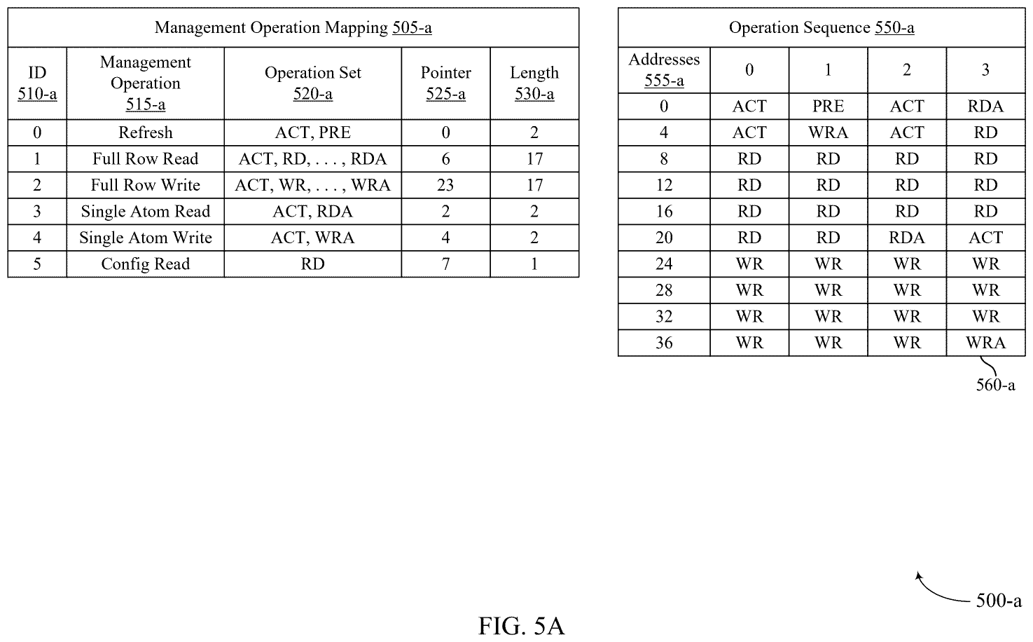

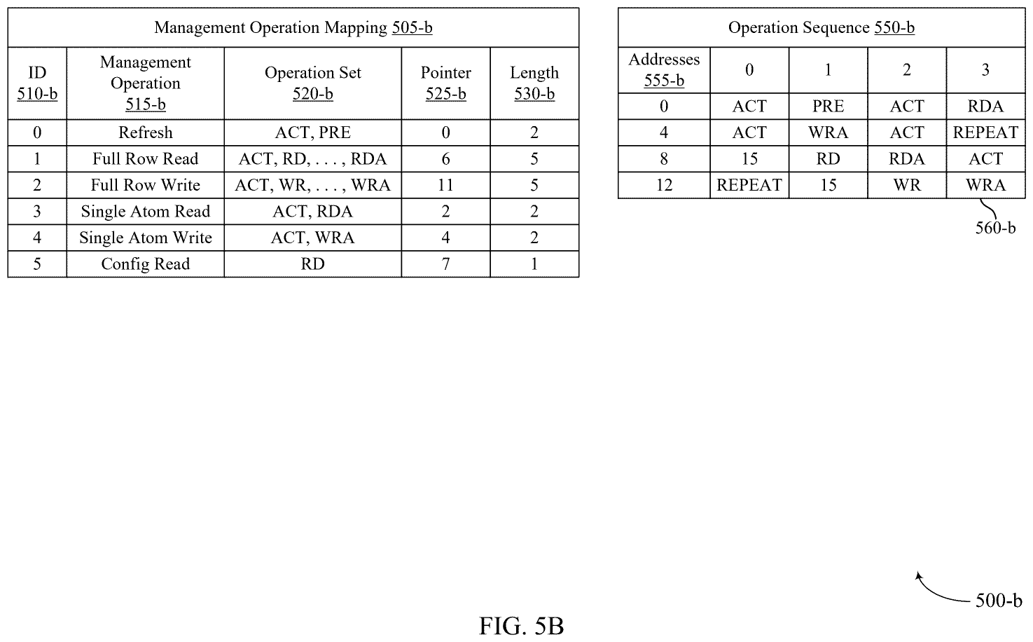

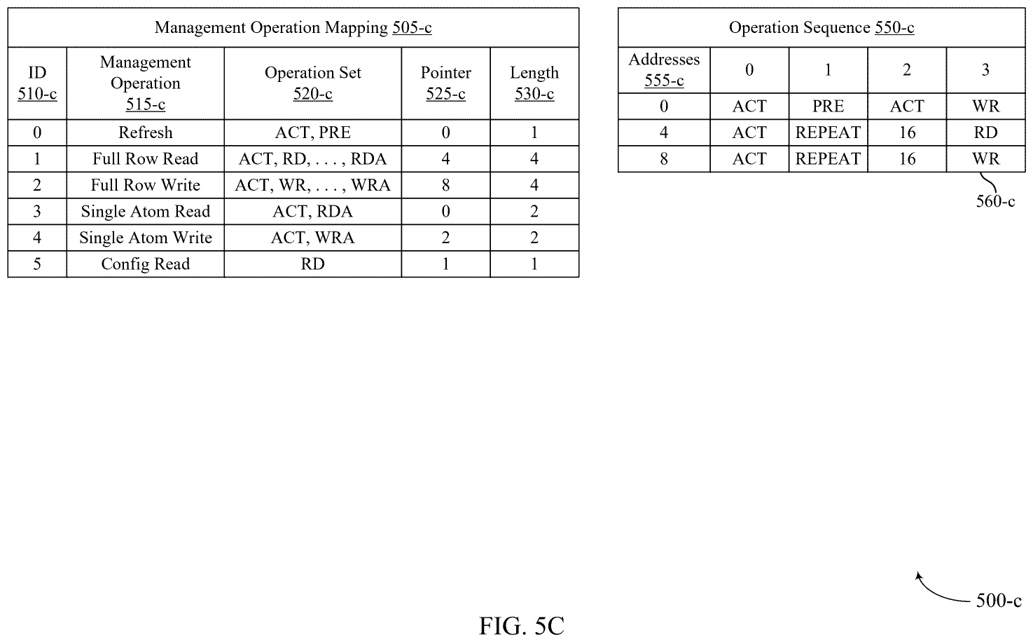

FIGS. 5A through 5C show examples of mappings 500 (e.g., mappings 500)-a. 500-b, and 500-c) that support management command microcode techniques for memory architectures in accordance with examples as disclosed herein. Aspects of a mapping 500) may be configured at a host system 105 (e.g., a controller 215, a controller) and a memory system 110 (e.g., an interface block 220), a logic block 225, a logic block 230, or a combination thereof, an interface) to support efficient and flexible techniques for the memory system 110 to request management operations and the host system 105 to coordinate responsive commands to the memory system 110.

Each example of a mapping 500 may include a management operation mapping 505 and an associated operation sequence 550) (e.g., a sequence of operations, a sequence of commands, a lookup reference). A management operation mapping 505 may map management operations 515 (e.g., types of management operations) with an operation set 520 (e.g., a respective set of one or more operations corresponding to a given management operation 515, a respective set of commands). For example, such management operations may include a refresh operation, a full row read operation, a full row write operation, a single atom (e.g., column, column set) read operation, a single atom write operation, and a config read operation, among other management operations (e.g., scrubbing operations, row repair operations) or combinations thereof. An associated operation sequence 550 may include a sequence of indicators 560) (e.g., operation indicators, command indicators, fields, entries) from which commands of the management operations 515 can be determined (e.g., by a controller 215, based on one or more indications of a management operation 515). Thus, in the examples of mappings 500, each management operation 515 may be associated with (e.g., by ID 510, by combination of pointer 525 and length 530) to a same operation sequence 550, which may involve relatively less storage than such mappings that separately (e.g., individually) map commands to each management operation (e.g., by implementing an overlap of command sets in an operation sequence 550).

An operation sequence 550) may be stored in a storage location accessible to the host system 105 (e.g., to the controller 215), such as one or more instances of non-volatile storage 235, one or more instances of non-volatile storage 270), or a combination thereof. In some examples, such storage may include a fuse array (e.g., of a die 205, of a die 240), which may be accessible (e.g., readable, programmable) via one or more terminals of the respective die (e.g., via one or more contacts 234, via a diagnostic interface, such as an Institute of Electrical and Electronics Engineers (IEEE) 1500 interface). In some examples, such indicators may refer to command IDs described with reference to Table 1, among other identifiers. Management operation mappings 505, operation sequences 550, or both may be loaded and/or updated over time, which may be more flexible than a fixed table.

In some examples, each management operation 515 may be associated with a pointer 525 (e.g., a starting address, a starting index, a starting indicator, an indicator of a first operation, an indicator of a first command) and a length 530 (e.g., a quantity of indicators, a quantity of operations, a quantity of commands) of the associated operation sequence 550. In the examples of mappings 500, indicators 560 of the operation sequences 550) are illustrated in a two-dimensional address space (e.g., of addresses 555). However, a sequence of operations in accordance with the described techniques can be represented in a one-dimensional set of indicators (e.g., a string), a two-dimensional set of indicators (e.g., an array), or other types of data structures.

The mappings 500 may be implemented in various ways to support the described techniques for indicating a management operation and scheduling responsive commands. In some examples, a host system 105 (e.g., a controller 215) may be configured with a mapping between IDs 510 and corresponding pointers 525 and lengths 530 (e.g., a configuration of at least a portion of the management operation mapping 505, which may be stored at a storage location accessible to the host system 105). In such examples, a memory system 110 (e.g., an interface block 220, a logic block 225, a logic block 230) may indicate an ID 510 (e.g., via a bus 350, with an MO request at 430 of the process 400) of a selected management operation 515 to a host system 105 (e.g., to a controller 215), and the host system 105 (e.g., at 440 of the process 400) may determine the pointer 525 and length 530 corresponding to the indicated ID 510. In some other examples, a memory system 110 may indicate the pointer 525 and the length 530 (e.g., via a bus 350, with an MO request at 430 of the process 400) corresponding to a selected management operation 515 to a host system 105 (e.g., using two indicators). In these and other implementations, the host system 105 may use the pointer 525 and length 530 to determine a set of one or more operations (e.g., commands) corresponding to the indicated management operation from the associated operation sequence, and transmit one or more responsive commands to the memory system 110.

FIG. 5A shows an example in which an operation sequence 550-a includes an indicator 560-a for each operation of the operation sets 520-a. For example, the operation sequence 550-a includes indications of activation operations (e.g., ACT indications), precharge operations (e.g., PRE indications), read operations (e.g., RD indications and RDA indications, which may be associated with different types of read operations, such as including or excluding an accompanying precharge, or different read sizes), and write operations (e.g., WR indications and WRA indications, which may be associated with different types of write operations, such as including or excluding an accompanying precharge, or different write sizes). The operation sequence 550-a also includes adjacent (e.g., repeated, sequential) indications of the same type of operation.

In the example of mapping 500-a, a “Full Row Read” operation may be mapped with corresponding operations of an operation set 520-a (e.g., ACT, RD×15, RDA) by a pointer 525-a of “6” (e.g., a seventh entry, corresponding to row address “4” and column address “2” of the operation sequence 550-a) and a length 530-a of “17” (e.g., a quantity of 17 operations, concluding with the RDA indication 560-a corresponding to row address “20” and column address “2” of the operation sequence 550-a). Other instances of management operations 515-a may be similarly mapped to indicators 560-a of the operation sequence 550-a. Thus, a memory system 110 may indicate a management operation 515-a (e.g., by ID 510-a, by combination of pointer 525-a and length 530-a), and a host system 105 may determine responsive operations (e.g., commands) that are each associated with a respective indicator 560-a of the operation sequence 550-a (e.g., in a one-to-one correspondence). In the example of mapping 500-a, the operation sequence 550-a may be relatively long, and may occupy a relatively large amount of storage (e.g., of non-volatile storage 235 or 270, or a combination thereof), but configuration or processing of the mapping 500-a may be relatively simple.

FIG. 5B shows an example in which an operation sequence 550-b includes indications to implement a repetition and corresponding quantities of repetitions. For example, the operation sequence 550-b includes indications of activation operations, precharge operations, read operations, and write operations, but does not include adjacent indications of the same type of operation. Rather, the operation sequence 550-b includes “REPEAT” indicators that are each followed in the sequence 550-b with a quantity of repetitions for a particular type of operation.

In the example of mapping 500-b, a “Full Row Read” operation may be mapped with corresponding operations of an operation set 520-b (e.g., ACT, RD×15, RDA) by a pointer 525-b of “6” (e.g., a seventh entry, corresponding to row address “4” and column address “2” of the operation sequence 550)-b) and a length 530-b of “5” (e.g., a quantity of 5 operations, concluding with the RDA indication 560-b corresponding to row address “8” and column address “2” of the operation sequence 550-b). Other instances of management operations 515-b may be similarly mapped to indicators 560-b of the operation sequence 550-b. In the example of the “Full Row Read” operation, the host system 105 may interpret the indicated combination of “REPEAT”+“15”+“RD” to repeat the RD operation or command a quantity of 15 times (e.g., as 15 RD commands of 445 in the process 400).

In the example of mapping 500-b, the operation sequence 550-b may be relatively short (e.g., compared to the operation sequence 550)-a of mapping 500-a), and occupy relatively less storage (e.g., of non-volatile storage 235 or 270), or a combination thereof). Although the example of operation sequence 550-b illustrates one example of such repeat indications, a mapping 500 may implement other types of repeat indications or interpretations. Moreover, some examples of operation sequences 550) may implement a combination of adjacent operations of the same type and repeat indications, such as when overhead associated with repeat indications would be greater than indicating the adjacent operations directly (e.g., as a pair of repeated operations).

FIG. 5C shows an example in which an operation sequence 550-c omits indicators for certain types of operations. For example, compared to the operation sequence 550-b, the operation sequence 550-c omits indicators for precharge operations, which may be assumed to be performed when closing a row of memory cells (e.g., after performing a read operation, after performing a write operation). Thus, the operation sequence 550-c includes indications of activation operations, read operations, and write operations, but does not include indications of precharge operations (e.g., as direct PRE indications or as indicated by the auto-precharge aspects of RDA indications or WRA indications). In the example of mapping 500)-c, the operation sequence 550-c includes repeat indications, but the described techniques for omitting indicators for certain types of operations may be implemented with or without such repeat indications.

In the example of mapping 500-c, a “Full Row Read” operation may be mapped with corresponding operations of an operation set 520-c (e.g., ACT, RD×15, RDA) by a pointer 525-c of “4” (e.g., a fifth entry, corresponding to row address “4” and column address “0” of the operation sequence 550-c) and a length 530-c of “4” (e.g., a quantity of 4 operations, concluding with the RD indication 560-c corresponding to row address “4” and column address “3” of the operation sequence 550-c). Other instances of management operations 515-c may be similarly mapped to indicators 560-c of the operation sequence 550-c. In the example of the “Full Row Read” operation, the host system 105 may interpret the indicated combination of “REPEAT”+“16”+“RD” to repeat the RD operation or command a quantity of 16 times (e.g., as 16 RD commands of 445 in the process 400), and may insert a PRE command at the end of the sequence (e.g., determining and scheduling a command not included in the operation sequence 550-c, determining a precharge command without a precharge indication being included in the operation sequence 550-c). In the example of mapping 500-b, the operation sequence 550-b may be relatively short (e.g., compared to the operation sequences 550-a and 550-b), and occupy even less storage (e.g., of non-volatile storage 235 or 270), or a combination thereof).

Thus, in accordance with these and other examples, interface circuitry (e.g., of a memory system 110, of an interface block 220 or a logic block 225) and a controller (e.g., of a host system 105, a controller 215) may be configured in accordance with a sequence of operations (e.g., in accordance with a management operation mapping 505 and an operation sequence 550), and respective management operations may each be associated with a pointer and a length of the sequence of operations. A controller may thus be configured to determine one or more commands for a management operation that is indicated by interface circuitry by referencing the configured sequence of operations in accordance with the pointer and length that are associated with the indicated management operation, which may involve repeat indicators, or omitting explicit indicators for certain operations, among other techniques or combinations thereof.

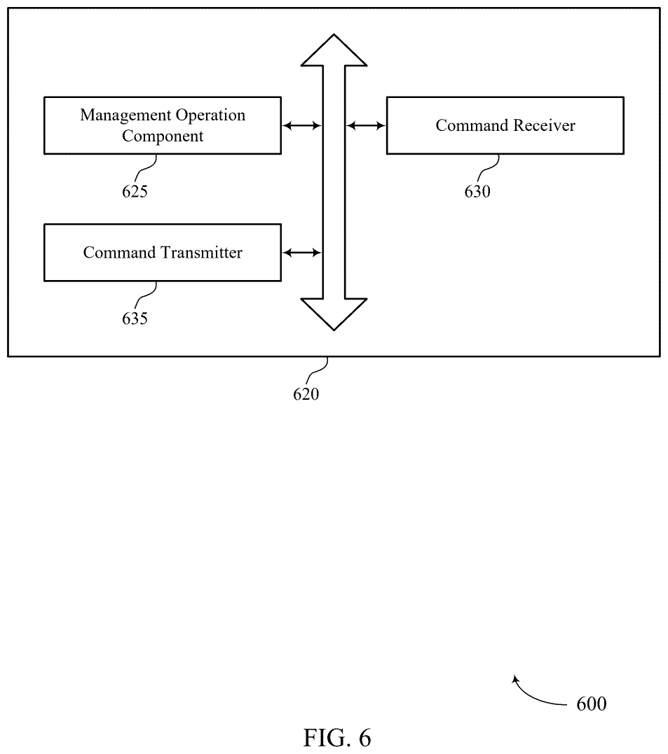

FIG. 6 shows a block diagram 600 of a memory interface block 620 (e.g., an interface of a memory system 110, an interface of a semiconductor die 205) that supports management command microcode techniques for memory architectures in accordance with examples as disclosed herein. The memory interface block 620 may be an example of aspects of one or more of a memory system controller 140, a local controller 150, an interface block 220), a logic block 225, or a combination thereof as described with reference to FIGS. 1 through 5C. The memory interface block 620, or various components thereof, may be an example of means for performing various aspects of management command microcode techniques for memory architectures as described herein. For example, the memory interface block 620 may include a management operation component 625, a command receiver 630, a command transmitter 635, or any combination thereof. Each of these components, or components of subcomponents thereof (e.g., one or more processors, one or more memories), may communicate, directly or indirectly, with one another (e.g., via one or more buses).

The management operation component 625 may be configured as or otherwise support a means for transmitting, from an interface of a first semiconductor component (e.g., a die 205) to a controller of the first semiconductor component, an indication of a management operation (e.g., an ID 510, a pointer 525 and a length 530) associated with one or more memory arrays (e.g., one or more memory arrays 155, one or more memory arrays 250) of one or more second semiconductor components (e.g., one or more dies 240) coupled with the first semiconductor component. The command receiver 630 may be configured as or otherwise support a means for receiving, at the interface from the controller based on transmitting the indication of the management operation, a plurality of first commands associated with the management operation. The command transmitter 635 may be configured as or otherwise support a means for transmitting, from the interface to at least one of the one or more second semiconductor components, a plurality of second commands associated with the management operation, each of the plurality of second commands corresponding to one of the plurality of first commands.

In some examples, the indication of the management operation is associated with a pointer and a length of a sequence of operations (e.g., of an operation sequence 550).

In some examples, the sequence of operations includes at least one indication of an activation operation, at least one indication of a read operation, and at least one indication of a write operation.

In some examples, the sequence of operations includes at least one indication of a precharge (e.g., pre-charge) operation.

In some examples, the sequence of operations includes at least one indication of a second read operation having a read size that is different from the read operation, at least one indication of a second write operation having a write size that is different from the write operation, or a combination thereof.

In some examples, the sequence of operations includes at least one indication to implement a repetition (e.g., a “REPEAT” indicator) and at least one indication of a corresponding quantity of repetitions.

In some examples, management operation component 625 may be configured as or otherwise support a means for selecting the management operation from a plurality of management operations each associated with a respective indication of a plurality of indications.

In some examples, each respective indication is associated with a respective pointer and a respective length of the same sequence of operations.

In some examples, the indication of the management operation includes an indicator of a type of management operation and an identifier for associating the plurality of first commands with the indication.

In some examples, the described functionality of the memory interface block 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory interface block 620, or various components thereof, may be implemented at least in part by instructions (e.g., stored in memory, non-transitory computer-readable medium) executable by such at least one processor.

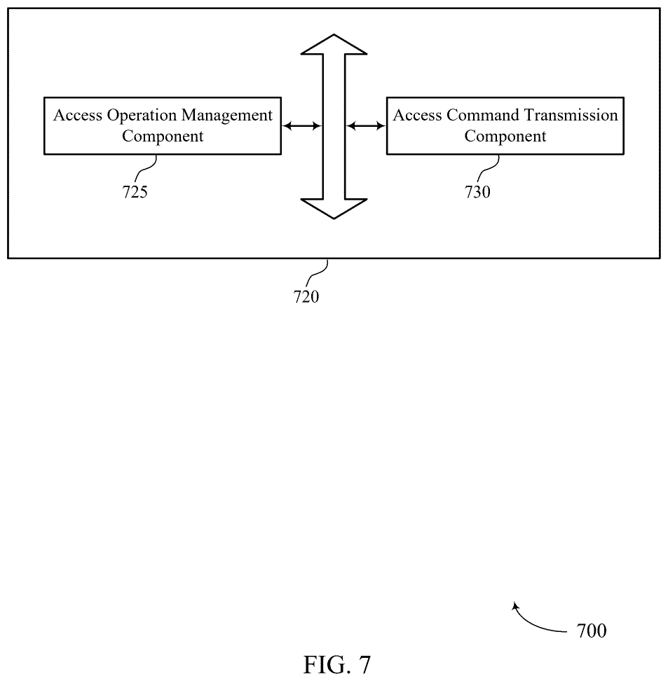

FIG. 7 shows a block diagram 700 of a memory controller 720 (e.g., a controller of a host system 105, an interface of a host system 105, a controller of a semiconductor die 205) that supports management command microcode techniques for memory architectures in accordance with examples as disclosed herein. The memory controller 720 may be an example of aspects of one or more of a host system controller 120, a controller 215, or a combination thereof as described with reference to FIGS. 1 through 5C. The memory controller 720, or various components thereof, may be an example of means for performing various aspects of management command microcode techniques for memory architectures as described herein. For example, the memory controller 720 may include an access operation management component 725, an access command transmission component 730, or any combination thereof. Each of these components, or components of subcomponents thereof (e.g., one or more processors, one or more memories), may communicate, directly or indirectly, with one another (e.g., via one or more buses).

The access operation management component 725 may be configured as or otherwise support a means for receiving, at a controller of a first semiconductor component (e.g., a die 205) from an interface of the first semiconductor component, an indication of a management operation associated with one or memory arrays (e.g., one or more memory arrays 155, one or more memory arrays 250) of one or more second semiconductor components (e.g., one or more dies 240) coupled with the first semiconductor component. The access command transmission component 730 may be configured as or otherwise support a means for transmitting, from the controller to the interface based on receiving the indication of the management operation, a plurality of commands each associated with a respective operation of the management operation.

In some examples, the access operation management component 725 may be configured as or otherwise support a means for determining the plurality of commands based on a pointer of a sequence of operations and a length of the sequence of operations that are both associated with the indication of the management operation (e.g., in accordance with a management operation mapping 505).

In some examples, the sequence of operations includes at least one indication of an activation operation, at least one indication of a read operation, and at least one indication of a write operation.

In some examples, the sequence of operations includes at least one indication of a precharge operation.

In some examples, the sequence of operations includes at least one indication of a second read operation having a read size that is different from the read operation, at least one indication of a second write operation having a write size that is different from the write operation, or a combination thereof.

In some examples, the sequence of operations includes at least one indication to implement a repetition and an indication of a corresponding quantity of repetitions.

In some examples, the access operation management component 725 may be configured as or otherwise support a means for determining at least one of the plurality of commands based on an operation not included in the sequence of operations.

In some examples, the access operation management component 725 may be configured as or otherwise support a means for determining at least one precharge command of the plurality of commands without a precharge operation being included in the sequence of operations.

In some examples, the indication of the management operation includes an indicator of a type of management operation and an identifier for associating the plurality of commands with the indication.

In some examples, the access operation management component 725 may be configured as or otherwise support a means for identifying the management operation, based on the indication of the management operation, from a plurality of management operations each associated with a respective indication of a plurality of indications.

In some examples, each respective indication is associated with a respective pointer and a respective length of the same sequence of operations.

In some examples, the described functionality of the memory controller 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory controller 720, or various components thereof, may be implemented at least in part by instructions (e.g., stored in memory, non-transitory computer-readable medium) executable by such at least one processor.

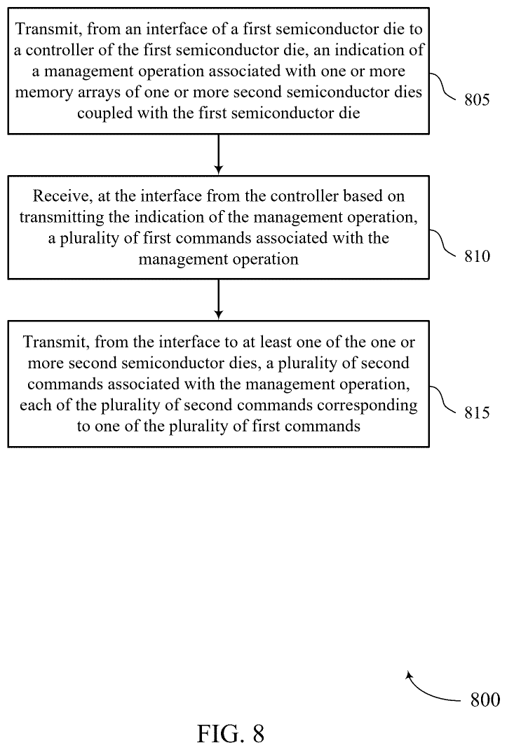

FIG. 8 shows a flowchart illustrating a method 800 that supports management command microcode techniques for memory architectures in accordance with examples as disclosed herein. The operations of method 800 may be implemented by a memory interface block (e.g., an interface of a memory system 110) or its components as described herein. For example, the operations of method 800 may be performed by a memory interface block (e.g., an interface block 220) as described with reference to FIGS. 1 through 6. In some examples, a memory interface block may execute a set of instructions to control the functional elements of the device to perform the described functions. Additionally, or alternatively, the memory interface block may perform aspects of the described functions using special-purpose hardware.

At 805, the method may include transmitting, from an interface (e.g., an interface block 220) of a first semiconductor component (e.g., a die 205) to a controller (e.g., a controller 215) of the first semiconductor component, an indication of a management operation associated with one or more memory arrays (e.g., one or more memory arrays 155, one or more memory arrays 250) of one or more second semiconductor components (e.g., one or more dies 240) coupled with the first semiconductor components. In some examples, aspects of the operations of 805 may be performed by a management operation component 625 as described with reference to FIG. 6.

At 810, the method may include receiving, at the interface from the controller based on transmitting the indication of the management operation, a plurality of first commands associated with the management operation. In some examples, aspects of the operations of 810 may be performed by a command receiver 630 as described with reference to FIG. 6.

At 815, the method may include transmitting, from the interface to at least one of the one or more second semiconductor components, a plurality of second commands associated with the management operation, each of the plurality of second commands corresponding to one of the plurality of first commands. In some examples, aspects of the operations of 815 may be performed by a command transmitter 635 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting, from an interface of a first semiconductor component (e.g., a semiconductor die) to a controller of the first semiconductor component, an indication of a management operation associated with one or more memory arrays of one or more second semiconductor components (e.g., one or more semiconductor dies) coupled with the first semiconductor component: receiving, at the interface from the controller based on transmitting the indication of the management operation, a plurality of first commands associated with the management operation; and transmitting, from the interface to at least one of the one or more second semiconductor components, a plurality of second commands associated with the management operation, each of the plurality of second commands corresponding to one of the plurality of first commands.

Aspect 2: The method, apparatus, or non-transitory computer-readable medium of aspect 1, where the indication of the management operation is associated with a pointer and a length of a sequence of operations.

Aspect 3: The method, apparatus, or non-transitory computer-readable medium of aspect 2, where the sequence of operations includes at least one indication of an activation operation, at least one indication of a read operation, and at least one indication of a write operation.

Aspect 4: The method, apparatus, or non-transitory computer-readable medium of aspect 3, where the sequence of operations includes at least one indication of a precharge operation.

Aspect 5: The method, apparatus, or non-transitory computer-readable medium of any of aspects 3 through 4, where the sequence of operations includes at least one indication of a second read operation having a read size that is different from the read operation, at least one indication of a second write operation having a write size that is different from the write operation, or a combination thereof.

Aspect 6: The method, apparatus, or non-transitory computer-readable medium of any of aspects 2 through 5, where the sequence of operations includes at least one indication to implement a repetition and at least one indication of a corresponding quantity of repetitions.

Aspect 7: The method, apparatus, or non-transitory computer-readable medium of any of aspects 1 through 6, further including operations, features, circuitry, logic, means, or instructions, or any combination thereof for selecting the management operation from a plurality of management operations each associated with a respective indication of a plurality of indications.

Aspect 8: The method, apparatus, or non-transitory computer-readable medium of aspect 7, where each respective indication is associated with a respective pointer and a respective length of the same sequence of operations.

Aspect 9: The method, apparatus, or non-transitory computer-readable medium of any of aspects 1 through 8, where the indication of the management operation includes an indicator of a type of management operation and an identifier for associating the plurality of first commands with the indication.

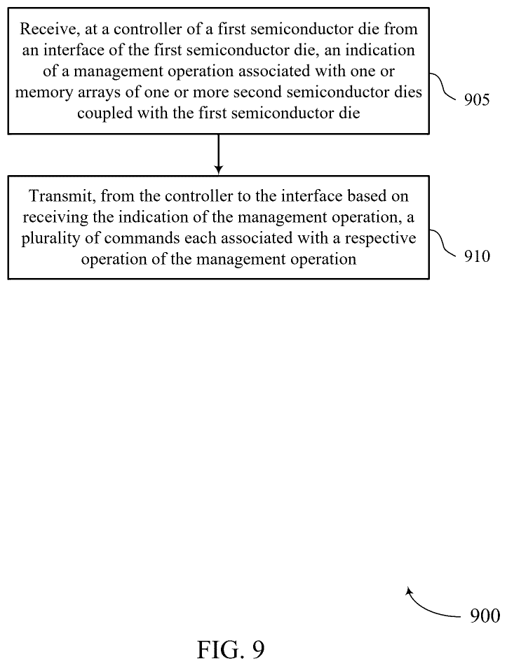

FIG. 9 shows a flowchart illustrating a method 900 that supports management command microcode techniques for memory architectures in accordance with examples as disclosed herein. The operations of method 900 may be implemented by a memory controller (e.g., a controller of a host system 105, an interface of a host system 105) or its components as described herein. For example, the operations of method 900 may be performed by a memory controller as described with reference to FIGS. 1 through 5C and 7. In some examples, a memory controller may execute a set of instructions to control the functional elements of the device to perform the described functions. Additionally, or alternatively, the memory controller may perform aspects of the described functions using special-purpose hardware.

At 905, the method may include receiving, at a controller (e.g., a controller 215) of a first semiconductor component (e.g., a die 205) from an interface (e.g., an interface block 220) of the first semiconductor component, an indication of a management operation associated with one or memory arrays (e.g., one or more memory arrays 155, one or more memory arrays 250) of one or more second semiconductor components (e.g., one or more dies 240) coupled with the first semiconductor component. In some examples, aspects of the operations of 905 may be performed by an access operation management component 725 as described with reference to FIG. 7.

At 910, the method may include transmitting, from the controller to the interface based on receiving the indication of the management operation, a plurality of commands each associated with a respective operation of the management operation. In some examples, aspects of the operations of 910 may be performed by an access command transmission component 730 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving, at a controller of a first semiconductor component from an interface of the first semiconductor component, an indication of a management operation associated with one or memory arrays of one or more second semiconductor components coupled with the first semiconductor component and transmitting, from the controller to the interface based on receiving the indication of the management operation, a plurality of commands each associated with a respective operation of the management operation.

Aspect 11: The method, apparatus, or non-transitory computer-readable medium of aspect 10, further including operations, features, circuitry, logic, means, or instructions, or any combination thereof for determining the plurality of commands based on a pointer of a sequence of operations and a length of the sequence of operations that are both associated with the indication of the management operation.

Aspect 12: The method, apparatus, or non-transitory computer-readable medium of aspect 11, where the sequence of operations includes at least one indication of an activation operation, at least one indication of a read operation, and at least one indication of a write operation.

Aspect 13: The method, apparatus, or non-transitory computer-readable medium of aspect 12, where the sequence of operations includes at least one indication of a precharge operation.

Aspect 14: The method, apparatus, or non-transitory computer-readable medium of any of aspects 12 through 13, where the sequence of operations includes at least one indication of a second read operation having a read size that is different from the read operation, at least one indication of a second write operation having a write size that is different from the write operation, or a combination thereof.

Aspect 15: The method, apparatus, or non-transitory computer-readable medium of any of aspects 11 through 14, where the sequence of operations includes at least one indication to implement a repetition and an indication of a corresponding quantity of repetitions.

Aspect 16: The method, apparatus, or non-transitory computer-readable medium of any of aspects 11 through 15, further including operations, features, circuitry, logic, means, or instructions, or any combination thereof for determining at least one of the plurality of commands based on an operation not included in the sequence of operations.

Aspect 17: The method, apparatus, or non-transitory computer-readable medium of aspect 16, further including operations, features, circuitry, logic, means, or instructions, or any combination thereof for determining at least one precharge command of the plurality of commands without a precharge operation being included in the sequence of operations.

Aspect 18: The method, apparatus, or non-transitory computer-readable medium of any of aspects 10 through 17, where the indication of the management operation includes an indicator of a type of management operation and an identifier for associating the plurality of commands with the indication.

Aspect 19: The method, apparatus, or non-transitory computer-readable medium of any of aspects 10 through 18, further including operations, features, circuitry, logic, means, or instructions, or any combination thereof for identifying the management operation, based on the indication of the management operation, from a plurality of management operations each associated with a respective indication of a plurality of indications.

Aspect 20: The method, apparatus, or non-transitory computer-readable medium of aspect 19, where each respective indication is associated with a respective pointer and a respective length of the same sequence of operations.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 21: An apparatus, including a first semiconductor component (e.g., a die 205) including an interface coupled with a controller, the interface including circuitry operable to: transmit, to the controller, an indication of a management operation associated with one or memory arrays of one or more second semiconductor components (e.g., one or more dies 240) coupled with the first semiconductor component: receive, from the controller based on transmitting the indication of the management operation, a plurality of first commands associated with the management operation; and transmit, to at least one of the one or more second semiconductor components, a plurality of second commands associated with the management operation, each of the plurality of second commands corresponding to one of the plurality of first commands.

Aspect 22: The apparatus of aspect 21, where the indication of the management operation is associated with a pointer and a length of a sequence of operations.

Aspect 23: The apparatus of aspect 22, where the sequence of operations includes at least one indication of an activation operation, at least one indication of a read operation, and at least one indication of a write operation.

Aspect 24: The apparatus of aspect 23, where the sequence of operations includes at least one indication of a precharge operation.

Aspect 25: The apparatus of any of aspects 23 through 24, where the sequence of operations includes at least one indication of a second read operation having a read size that is different from the read operation, at least one indication of a second write operation having a write size that is different from the write operation, or a combination thereof.

Aspect 26: The apparatus of any of aspects 22 through 25, where the sequence of operations includes at least one indication to implement a repetition and at least one indication of a corresponding quantity of repetitions.

Aspect 27: The apparatus of any of aspects 21 through 26, where the circuitry is further operable to select the management operation from a plurality of management operations each associated with a respective indication of a plurality of indications.

Aspect 28: The apparatus of aspect 27, where each respective indication is associated with a respective pointer and a respective length of the same sequence of operations.

Aspect 29: The apparatus of any of aspects 21 through 28, where the indication of the management operation includes an indicator of a type of management operation and an identifier for associating the plurality of first commands with the indication.

An apparatus is described. The following provides an overview of aspects of the apparatus as described herein:

Aspect 30: An apparatus, including a first semiconductor component (e.g., a die 205) including an interface coupled with a controller, the controller including circuitry operable to: receive, from the interface, an indication of a management operation associated with one or memory arrays of one or more second semiconductor components coupled with the first semiconductor component; and transmit, to the interface based on receiving the indication of the management operation, a plurality of commands each associated with a respective operation of the management operation.

Aspect 31: The apparatus of aspect 30, where the circuitry is further operable to: determine the plurality of commands based on a pointer of a sequence of operations and a length of the sequence of operations that are both associated with the indication of the management operation.

Aspect 32: The apparatus of aspect 31, where the circuitry includes a storage location operable to store the sequence of operations, to update the sequence of operations, or both.

Aspect 33: The apparatus of any of aspects 31 through 32, where the sequence of operations includes at least one indication of an activation operation, at least one indication of a read operation, and at least one indication of a write operation.

Aspect 34: The apparatus of aspect 33, where the sequence of operations includes at least one indication of a precharge operation.

Aspect 35: The apparatus of any of aspects 33 through 34, where the sequence of operations includes at least one indication of a second read operation having a read size that is different from the read operation, at least one indication of a second write operation having a write size that is different from the write operation, or a combination thereof.

Aspect 36: The apparatus of any of aspects 31 through 35, where the sequence of operations includes at least one indication to implement a repetition and an indication of a corresponding quantity of repetitions.

Aspect 37: The apparatus of any of aspects 31 through 36, where the circuitry is further operable to determine at least one of the plurality of commands based on an operation not included in the sequence of operations.

Aspect 38: The apparatus of aspect 37, where the circuitry is further operable to determine at least one precharge command of the plurality of commands without a precharge operation being included in the sequence of operations.

Aspect 39: The apparatus of any of aspects 30 through 38, where the indication of the management operation includes an indicator of a type of management operation and an identifier for associating the plurality of commands with the indication.

Aspect 40: The apparatus of any of aspects 30 through 39, where the circuitry is further operable to identify the management operation, based on the indication of the management operation, from a plurality of management operations each associated with a respective indication of a plurality of indications.

Aspect 41: The apparatus of aspect 40, where each respective indication is associated with a respective pointer and a respective length of the same sequence of operations.

A system is described. The following provides an overview of aspects of the system as described herein:

Aspect 42: A system, including one or more first semiconductor components (e.g., one or more dies 240) including: one or more memory arrays; and one or more first interfaces each including first circuitry operable to access at least one corresponding memory array of the one or more memory arrays; and a second semiconductor component (e.g., a die 205) coupled with the one or more first semiconductor components, the second semiconductor component including: one or more controllers, each controller operable to: receive commands to access the one or more memory arrays; and schedule access of the one or more memory arrays based on receiving the commands; and one or more second interfaces coupled with the one or more controllers, each second interface including second circuitry operable to: transmit, to a controller of the one or more controllers, an indication of a management operation associated with at least one memory array of the one or more memory arrays: receive, from the controller based on transmitting the indication of the management operation, a plurality of first commands each associated with the management operation; and transmit, to at least one of the one or more first interfaces, a plurality of second commands associated with the management operation, each of the plurality of second commands corresponding to one of the plurality of first commands.

Aspect 43: The system of aspect 42, where the indication of the management operation is associated with a pointer and a length of a sequence of operations.

Aspect 44: The system of aspect 43, where the sequence of operations includes at least one indication of an activation operation, at least one indication of a read operation, and at least one indication of a write operation.

Aspect 45: The system of aspect 44, where the sequence of operations includes at least one indication of a precharge operation.

Aspect 46: The system of any of aspects 43 through 45, where the sequence of operations includes at least one indication to implement a repetition and at least one indication of a corresponding quantity of repetitions.

Aspect 47: The system of any of aspects 42 through 46, where the second circuitry is further operable to select the management operation from a plurality of management operations each associated with a respective indication of a plurality of indications.

Aspect 48: The system of aspect 47, where each respective indication is associated with a respective pointer and a respective length of the same sequence of operations.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal: however, the signal may represent a bus of signals, where the bus may have a variety of bit widths.

The terms “electronic communication,” “conductive contact.” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The terms “layer” and “level” may refer to an organization (e.g., a stratum, a sheet) of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, or materials. In some examples, one layer or level may be composed of two or more sublayers or sublevels.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a.” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components.” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a first semiconductor component comprising an interface coupled with a controller, the interface comprising circuitry operable to:
transmit, to the controller, an indication of a management operation associated with one or memory arrays of one or more second semiconductor components coupled with the first semiconductor component;
receive, from the controller based on transmitting the indication of the management operation, a plurality of first commands associated with the management operation; and
transmit, to at least one of the one or more second semiconductor components, a plurality of second commands associated with the management operation, each of the plurality of second commands corresponding to one of the plurality of first commands.

2. The apparatus of claim 1, wherein the indication of the management operation is associated with a pointer and a length of a sequence of operations.

3. The apparatus of claim 2, wherein the sequence of operations comprises at least one indication of an activation operation, at least one indication of a read operation, and at least one indication of a write operation.

4. The apparatus of claim 3, wherein the sequence of operations comprises at least one indication of a precharge operation.

5. The apparatus of claim 3, wherein the sequence of operations comprises at least one indication of a second read operation having a read size that is different from the read operation, at least one indication of a second write operation having a write size that is different from the write operation, or a combination thereof.

6. The apparatus of claim 2, wherein the sequence of operations comprises at least one indication to implement a repetition and at least one indication of a corresponding quantity of repetitions.

7. The apparatus of claim 1, wherein the circuitry is further operable to:
select the management operation from a plurality of management operations each associated with a respective indication of a plurality of indications.

8. The apparatus of claim 7, wherein each respective indication is associated with a respective pointer and a respective length of the same sequence of operations.

9. The apparatus of claim 1, wherein the indication of the management operation comprises an indicator of a type of management operation and an identifier for associating the plurality of first commands with the indication.

10. An apparatus, comprising:
a first semiconductor component comprising an interface coupled with a controller, the controller comprising circuitry operable to:
receive, from the interface, an indication of a management operation associated with one or memory arrays of one or more second semiconductor components coupled with the first semiconductor component; and
transmit, to the interface based on receiving the indication of the management operation, a plurality of commands each associated with a respective operation of the management operation.

11. The apparatus of claim 10, wherein the circuitry is further operable to:
determine the plurality of commands based on a pointer of a sequence of operations and a length of the sequence of operations that are both associated with the indication of the management operation.

12. The apparatus of claim 11, wherein the circuitry comprises a storage location operable to store the sequence of operations, to update the sequence of operations, or both.

13. The apparatus of claim 11, wherein the sequence of operations comprises at least one indication of an activation operation, at least one indication of a read operation, and at least one indication of a write operation.

14. The apparatus of claim 13, wherein the sequence of operations comprises at least one indication of a precharge operation.

15. The apparatus of claim 13, wherein the sequence of operations comprises at least one indication of a second read operation having a read size that is different from the read operation, at least one indication of a second write operation having a write size that is different from the write operation, or a combination thereof.

16. The apparatus of claim 11, wherein the sequence of operations comprises at least one indication to implement a repetition and an indication of a corresponding quantity of repetitions.

17. The apparatus of claim 11, wherein the circuitry is further operable to:
determine at least one of the plurality of commands based on an operation not included in the sequence of operations.

18. The apparatus of claim 17, wherein the circuitry is further operable to:
determine at least one precharge command of the plurality of commands without a precharge operation being included in the sequence of operations.

19. The apparatus of claim 10, wherein the indication of the management operation comprises an indicator of a type of management operation and an identifier for associating the plurality of commands with the indication.

20. The apparatus of claim 10, wherein the circuitry is further operable to:
identify the management operation, based on the indication of the management operation, from a plurality of management operations each associated with a respective indication of a plurality of indications.

21. The apparatus of claim 20, wherein each respective indication is associated with a respective pointer and a respective length of the same sequence of operations.

22. A system, comprising:
one or more first semiconductor components comprising:
one or more memory arrays; and
one or more first interfaces each comprising first circuitry operable to access at least one corresponding memory array of the one or more memory arrays; and
a second semiconductor component coupled with the one or more first semiconductor components, the second semiconductor component comprising:
one or more controllers, each controller operable to:
receive commands to access the one or more memory arrays; and
schedule access of the one or more memory arrays based on receiving the commands; and
one or more second interfaces coupled with the one or more controllers, each second interface comprising second circuitry operable to:
transmit, to a controller of the one or more controllers, an indication of a management operation associated with at least one memory array of the one or more memory arrays;
receive, from the controller based on transmitting the indication of the management operation, a plurality of first commands each associated with the management operation; and
transmit, to at least one of the one or more first interfaces, a plurality of second commands associated with the management operation, each of the plurality of second commands corresponding to one of the plurality of first commands.

23. The system of claim 22, wherein the indication of the management operation is associated with a pointer and a length of a sequence of operations.

24. The system of claim 23, wherein the sequence of operations comprises at least one indication of an activation operation, at least one indication of a read operation, and at least one indication of a write operation.

25. The system of claim 24, wherein the sequence of operations comprises at least one indication of a precharge operation.

26. The system of claim 23, wherein the sequence of operations comprises at least one indication to implement a repetition and at least one indication of a corresponding quantity of repetitions.

27. The system of claim 22, wherein the second circuitry is further operable to:
select the management operation from a plurality of management operations each associated with a respective indication of a plurality of indications.

28. The system of claim 27, wherein each respective indication is associated with a respective pointer and a respective length of the same sequence of operations.

29. A method, comprising:
transmitting, from an interface of a first semiconductor component to a controller of the first semiconductor component, an indication of a management operation associated with one or more memory arrays of one or more second semiconductor components coupled with the first semiconductor component;
receiving, at the interface from the controller based on transmitting the indication of the management operation, a plurality of first commands associated with the management operation; and
transmitting, from the interface to at least one of the one or more second semiconductor components, a plurality of second commands associated with the management operation, each of the plurality of second commands corresponding to one of the plurality of first commands.

30. A method, comprising:
receiving, at a controller of a first semiconductor component from an interface of the first semiconductor component, an indication of a management operation associated with one or memory arrays of one or more second semiconductor components coupled with the first semiconductor component; and
transmitting, from the controller to the interface based on receiving the indication of the management operation, a plurality of commands each associated with a respective operation of the management operation.
